(19) United States
(12) Patent Application Publication
(10) Pub. No.: US 2020/0315194 A1
(43) Pub. Date: Oct. 8, 2020

(54) Zero-OxTech® Process for preservation of enzymes in the protein muscle and its applications

(71) Applicant: Gaurav Tewari, Richmond Hill (CA)

(72) Inventor: Gaurav Tewari, Richmond Hill (CA)

(21) Appl. No.: 16/859,757

(22) Filed: Apr. 27, 2020

Related U.S. Application Data
(63) Continuation-in-part of application No. 10/192,916, filed on Jul. 9, 2002, now abandoned.
Application No. 10/192,916 is a continuation-in-part of application No. 10/434,010, filed on May 8, 2003, now abandoned.
Application No. 10/434,010 is a continuation-in-part of application No. 11/366,148, filed on Mar. 2, 2006, now abandoned.
Application No. 11/366,148 is a continuation-in-part of application No. 11/366,726, filed on Mar. 2, 2006, now abandoned.
Application No. 11/366,726 is a continuation-in-part of application No. 12/074,054, filed on Feb. 29, 2008, now abandoned.
Application No. 12/074,054 is a continuation-in-part of application No. 16/821,649, filed on Mar. 17, 2020.
Application No. 16/821,649 is a continuation-in-part of application No. 10/192,916, filed on Jul. 9, 2002, now abandoned.
Application No. 10/192,916 is a continuation-in-part of application No. 10/434,010, filed on May 8, 2003, now abandoned.
Application No. 10/434,010 is a continuation-in-part of application No. 11/366,148, filed on Mar. 2, 2006, now abandoned.
Application No. 16/821,649 is a continuation-in-part of application No. 11/366,726, filed on Mar. 2, 2006, now abandoned.
Application No. 11/366,726 is a continuation-in-part of application No. 12/074,054, filed on Feb. 29, 2008, now abandoned.
Application No. 12/074,054 is a continuation-in-part of application No. 10/192,916, filed on Jul. 9, 2002, now abandoned.
Application No. 10/192,916 is a continuation-in-part of application No. 10/434,010, filed on May 8, 2003, now abandoned.
Application No. 10/434,010 is a continuation-in-part of application No. 11/366,148, filed on Mar. 2, 2006, now abandoned.
Application No. 11/366,148 is a continuation-in-part of application No. 11/366,726, filed on Mar. 2, 2006, now abandoned.
Application No. 11/366,726 is a continuation-in-part of application No. 10/192,916, filed on Jul. 9, 2002, now abandoned.
Application No. 11/366,148 is a continuation-in-part of application No. 10/434,010, filed on May 8, 2003, now abandoned.
Application No. 11/366,726 is a continuation-in-part of application No. 10/192,916, filed on Jul. 9, 2002, now abandoned.
Application No. 10/192,916 is a continuation-in-part of application No. 10/434,010, filed on May 8, 2003, now abandoned.
Application No. 10/434,010 is a continuation-in-part of application No. 10/192,916, filed on Jul. 9, 2002, now abandoned.
(60) Provisional application No. 63/001,768, filed on Mar. 30, 2020.
(60) Provisional application No. 60/303,985, filed on Jul. 9, 2001.

(51) Int. Cl. A23B 4/16; A23L 3/3436; B65D 81/24; B65D 81/20; B65B 25/00; B65B 31/04

(52) U.S. Cl. CPC A23B 4/16; A23L 3/3436; B65D 81/24; A23V 2002/00; B65B 25/001; B65B 31/048; B65D 81/2007

(57) ABSTRACT

The present invention relates to Zero-OxTech® process and method for preserving natural enzymes with the protein muscle, and its application for increasing the shelf-life of retail-ready meat & poultry cuts. This invention explicitly proves that the oxygen absorption is a FIRST-ORDER chemical reaction, and henceforth, an absolute zero-oxygen atmosphere is possible. This absolute zero-oxygen atmosphere prevents the natural enzymes within the protein muscle, which assists in the long-term shelf-life extension of proteins. The Zero-OxTech® process, its components, and its application for proteins' enzymes preservation is described in detail in this invention and has application for domestic and inter-continental trade of proteins while retaining the natural protein enzymes.

### RELATED APPLICATION DATA

This application is a continuation-in-part of U.S. application Ser. No. 10/192,916, U.S. application Ser. No. 11/366,148; U.S. application Ser. No. 11/366,726; U.S. application Ser. No. 12/074,054 and U.S. application Ser. No. 10/434,010 and claims the benefit of U.S. Provisional Application 60/303,985; U.S. Provisional Application 60/729,077; U.S. Provisional Application 38/892,768. This application is divisional application of Canadian Application 3,043,728 and Canadian Application 8,211,908.

### TECHNICAL FIELD OF THE INVENTION

The present invention relates to Zero-OxTech® process and method for preserving natural enzymes with the protein muscle, and its application for increasing the shelf-life of retail-ready meat & poultry cuts. This invention explicitly proves that the oxygen absorption is a FIRST-ORDER chemical reaction, and henceforth, an absolute zero-oxygen atmosphere is possible. This absolute zero-oxygen atmosphere prevents the natural enzymes within the protein muscle, which assists in the long-term shelf-life extension of proteins. The Zero-OxTech® process, its components, and its application for proteins' enzymes preservation is described in detail in this invention and has application for domestic and inter-continental trade of proteins while retaining the natural protein enzymes.

### BACKGROUND OF THE INVENTION

Meat production and packaging is well known in the industry. Meat Industry always desired “less mortality” rates and “fast” growth of animals/birds for the protein industry, due to which several hormones and antibiotics have been added to animals/birds during pre-birth and post-birth. Over time, such practice resulted in the development of antibiotics resistance in humans and detrimental health defects. As a result of which, such practices are currently being not appreciated and are at a decline. Despite work done in improving the health of animals/birds and using antimicrobial interventions at the meat harvesting/processing to provide safe protein [meat/protein] to consumers, natural enzymes within the protein muscle are lost. This invention relates to preservation of natural protein enzymes within the protein muscle so protein [meat/poultry] can have better retention of its natural/intrinsic properties, which in turn results in long extension of shelf-lives. These natural enzymes are lost when there is anti-microbial intervention during meat/poultry harvesting. The natural enzymes are lost at a very fast rate after harvesting, unless they are placed in an absolute zero-oxygen environment. One such group of enzymes is called MRA enzyme, which when exposed to even small traces of oxygen, dissipates very fast and never retained. The hypothesis behind development of Zero-OxTech® is to create an absolute zero-oxygen environment as soon as the protein muscle [meat/poultry] is harvested to preserve MRA group of enzymes.

MRA group of enzymes are very potent and have the capability to return the discolored state of meat to its original color but are present in a very limited quantity and are very susceptible to the presence of oxygen, especially small traces of oxygen. Protein muscle color, myoglobin, consists of three structures: oxymyoglobin [bright red cherry meat color], de-oxymyoglobin [purplish red color of meat], and metmyoglobin [greyish color of meat, commonly known as “discolored” meat]. When protein muscle is exposed to oxygen or even small traces of oxygen, oxymyoglobin [red color] converts very rapidly to metmyoglobin [greyish color], and this reaction is irreversible. When there is ABSOLUTE zero-oxygen, oxymyoglobin converts to de-oxymyoglobin and when meat-muscle is exposed to oxygen, de-oxymyoglobin converts to oxymyoglobin, which is called re-blooming of meat. Even if small traces of oxygen are present, de-oxymyoglobin also converts to metmyoglobin, and this reaction is irreversible [FIGS. 1-2]. However, MRA group of enzymes have the capability to convert the metmyoglobin to de-oxymyoglobin state, but these enzymes are depleted in doing so. If these MRA enzymes are retained, they have natural ability to preserve protein muscle for a very long time. However, this had been not possible since there had no process developed which can offer absolute zero-oxygen atmosphere to protein muscle. Even vacuum packaging has traces of oxygen, which depletes MRA group of enzymes. That is why Zero-OxTech® process is invented to offer absolute zero-oxygen atmosphere to preserve MRA enzymes.

There are 3 key components of Zero-OxTech® process:
1. Oxygen scavenger design
2. Packaging film design
3. Equipment selection and design
1. Oxygen scavenger design: Traditionally, oxygen scavengers are designed to remove “x” volume of oxygen from the package over period without concern about the rate of absorption. In addition, absorption of gases as per Mass Equilibrium theory has been considered a Second Order Reaction, i.e., gas-absorption can never be zero since gas-absorption is a logarithmic curve. Under the present invention, it was proved that design of oxygen scavenger can be made in such a manner that the gas-absorption becomes a First Order Reaction resulting in Zero-Oxygen Atmosphere.
   For this purpose, detailed oxygen absorption kinetics study was performed as below.

Experiment #1 Oxygen Absorption Kinetics to Deliver Zero-Oxygen Atmosphere as Desired in Zero-OxTech®

The current commercial design of O₂ scavengers generally involve packs in which the atmosphere contains some substantial fraction of O₂, if not air, at the time of pack sealing and the inhibition of chemical reactions or proliferation of microorganisms that proceed relatively slowly. Consequently, commercial O₂ scavengers are designed to remove a specified amount of O₂ from a relatively high O₂ atmosphere over periods of a day or more. The rate of O₂ absorption has then not been a principal concern in the design of commercial O₂ scavengers. However, TO PRESERVE “MRA GROUP OF ENZYMES”, rate of oxygen absorption is the key and is of prime importance.

The O₂ absorption rates of O₂ scavengers vary with the natures of their reactants and other materials used in their construction. Rates of absorption may also be affected by factors such as temperature and the compositions of the atmospheres to which they are exposed. Therefore, the objective of this study was to design an oxygen scavenger for “THE PRESERVATION OF MRA ENZYMES” after studying the O₂ absorption kinetics of O₂ scavengers based upon enzymes and iron chemical systems.

### Materials and Methods

1. O₂ Scavengers

Self-activated O₂ scavengers based upon iron chemical systems and enzymes were manufactured. Since scavengers based upon iron chemical system may form carboxylic acid in the presence of CO₂ atmosphere, henceforth, 100% nitrogen atmosphere or combination of CO₂ and N₂ should be given preference to obtain maximum oxygen absorption rates from these scavengers.

2. Absorption of O₂ by Scavengers

O₂ scavengers were placed in gas impermeable bags composed of a laminate of polyester, oriented nylon, and an EVOH/EVA co extrusion with an O₂ transmission rate of 0.55 mL per m² per 24 hours at 23° C., 70% relative humidity. Bags containing scavengers were either emptied of air by flattening each bag around the scavengers or were evacuated then filled with a known volume of N₂ or CO₂, using a controlled atmosphere packaging (CAP) machine, before being sealed. Then, a quantity of air was injected into each bag using a gas-tight syringe inserted through a stick-on septum (Modem Controls, Inc., Minneapolis, Minn., USA).

Immediately after the injection of air, the puncture-point was sealed using a hot iron. Each filled bag was stored at room or a constant temperature. Samples (8 mL) of the atmosphere in each bag were obtained every hour for 8 hours by means of a gas tight syringe inserted through a stick-on septum. If no substantial O₂ absorption was noticed within 8 hours, samples were taken after every 12 hours for up to 96 hours. Immediately after each sampling, the O₂ concentration in the sample was determined using an O₂ analyzer (Mocon MS0750, Modem Controls, Inc., Minneapolis, Minn., USA) with a zirconium oxide sensor, and the puncture-point was then sealed using a hot iron. Residual air in the emptied bag was measured as the volume of water displaced by the emptied bag and was used in the calculation.

To examine the effects of temperature and initial O₂ concentrations on O₂ absorption rates, scavengers were placed in bags after the scavengers, in their original sealed package, had been held overnight at the temperature at which O₂ absorption was to be measured. For each of the two scavengers at each temperature, six bags were prepared. Three of the bags were emptied of air, and sealed, and then 240 mL of air was injected into each. The other three were each filled with 4.5 L of N₂ before being sealed, and then 15 mL of air was injected into each. For each of the two scavenger types based upon scavenging mechanism, two sets of six bags were prepared, with one set being stored at each of the temperatures 25, 12, 2 or −1.5° C.

To characterize O₂ absorption when O₂ scavengers were placed inside over-wrapped retail trays within master packs, a 216×133×25 mm (L×W×H) retail tray over-wrapped with a film of O₂ transmission rate of 8000 mL per m² per 24 hours at 23° C., 70% relative humidity, containing scavengers, based upon iron chemical system, was placed in each of the six bags. A 5 mm hole was made at one corner of the over-wrapped film to allow free exchange of atmospheres during gas flushing, three bags were emptied of air and sealed, and then 240 mL of air was injected into each. The other three bags were each filled with 4.5 L of N₂ to which 15 mL of air was added by injection.

3. Data Analysis

The half-life of O₂ in a pack atmosphere was calculated as the time required for the O₂ concentration in the pack atmosphere to be reduced to half the initial value. The half-life was calculated from the volumes of O₂ at successive time intervals during the storage of the pack. In calculating the volumes of O₂ absorbed from each atmosphere of air by the scavenger, the initial volume of air was taken to be the 240 mL added to the pack plus the measured volume of residual air. The volume of O₂ in a pack at the end of any period was calculated as the volume of atmosphere at the end of the period multiplied by the concentration of O₂ in the atmosphere at that time. The volume of atmosphere at the beginning of each period was taken to be the volume of atmosphere at the beginning of the previous period less the volume of the atmosphere removed as a sample at the end of the period and the volume of O₂ calculated to have been absorbed during the previous period.

The volume of O₂ absorbed during a period was calculated as the volume of atmosphere at the start of the previous period multiplied by the concentration of O₂ in the atmosphere at the beginning of the period less the volume of atmosphere at the start of the period multiplied by the concentration of O₂ at the end of the period. In calculating the volumes of O₂ remained in the pack in atmospheres of N₂ or CO₂ to which air was added, the volumes of the atmosphere removed during sampling and the volumes of O₂ absorbed during a period were neglected.

To determine the order of reaction, plots were prepared of the natural logs (ln) and the reciprocals of the volumes of O₂ remaining in the pack atmosphere against time. If the ln plot approximated a straight line, the reaction was regarded as first order. If the reciprocal plot approximated a straight line, the reaction was regarded as second order. Rate-constants were calculated using the following equations:

for first-order reactions

ln[A]ₜ=−kt+ln[A]₀ [Equation 1]

and

for second-order reactions

$$\frac{1}{{[ A ]}_{t}} = k t + \frac{1}{{[ A ]}_{0}} \qquad [ Equation 2 ]$$

where, [A]ₜ=amount of reactant A at time t (h),

k=the rate-constant (hour⁻¹), and

[A]₀=the initial amount of reactant.

Frequency factors and activation energies were calculated from the Arrhenius Equation of the form

$$ln ( k ) = ( \frac{- {E}_{a}}{R} ) ( \frac{1}{T} ) + ln ( A ) \qquad [ Equation 3 ]$$

where,

A=frequency factor (frequency of collisions),

Eₐ=activation energy (J mol¹⁻),

R=universal gas constant (8.314 J mol⁻¹ K⁻¹), and

T=temperature (K).

4. Results

Using scavengers based upon iron chemical system in bags containing air, the O₂ half-life was four times longer at −1.5° C. than at 25° C., but with a N₂ atmosphere, the O₂ half-life at −1.5° C. was only double that at 25° C. (FIG. 1A). The O₂ half-life in bags containing air and scavengers based upon enzymes was seven times longer at −1.5° C. than at 25° C. but was only two and a half times longer at −1.5° C. than at 25° C. with a N₂ atmosphere (FIG. 1A). The O₂ absorption reaction was first order for all the O₂ scavengers (FIG. 1B).

### DISCUSSION

The initial O₂ concentrations affected the O₂ half-lives substantially for any scavenger type resulting in longer O₂ half-lives for the low initial O₂ concentration of 500 ppm in N atmospheres than for the high initial O₂ concentration of 200,000 ppm in air at the same temperature. Scavengers based upon iron chemical systems have shorter O₂ half-lives than the scavengers based upon enzymes. The kinetic data of the present study showed that the O₂ absorption reaction was a “first order” at both high (20%) and low (500 ppm) initial O₂ concentrations and included initial O₂ concentration as a limiting factor. Thus, proving that with proper design of the oxygen scavenger while maintaining an initial concentration of O₂, and using an ultra-high barrier film structure, oxygen absorption shall be of FIRST-ORDER, and henceforth, achieving a ZERO-OXYGEN atmosphere is possible, thereby preserving the “MRA group of enzymes”. For preservation of MRA enzymes within the protein muscle, absolute zero-oxygen is needed surrounding the meat, for which Zero-OxTech® process is invented, and requires a specially-designed oxygen scavengers based on the calculations as per the Equations 1-3, to achieve zero-oxygen within shortest possible time. This invention clearly distinguishes between low-oxygen atmosphere VS absolute zero-oxygen atmosphere, where the latter is required for the prevention of MRA enzymes within the protein muscle, and which is the integral part of the invented Zero-OxTech® process.

At high initial O₂ concentration, other factors, such as the scavenger surface area, and environment, may also affect the O₂ absorption rates. However, at low initial O₂ concentrations a diffusion-phenomenon, which is a derivative of O₂ concentration, was the dominant influence and resulted in low O₂ absorption. A threshold O₂ concentration existed where there was a dramatic decrease in O₂ absorption rate and initial O₂ concentration became the primary limiting factor for the O₂ absorption rate. Consequently, different rate-constants were observed for the same O₂ absorption curve at the same temperature, depending upon initial O₂ concentration. Therefore, the overall O₂ absorption curve produced by the scavenger was bi-phasic, which indicates that when an initial oxygen concentration is maintain, the oxygen absorption rates becomes first-order, and hence, ZERO-OXYGEN atmosphere is possible, which is the integral part of the Zero-OxTech® process.

The effect of the positioning of scavengers within packs was also substantial which suggests that despite its high O₂ permeability, the barrier film acted as an O₂ barrier at low O₂ concentrations. Additionally, its barrier effect may increase with decreasing temperature. Consequently, the size of the hole in the lidding film is likely the limiting factor for O₂ absorption when retail trays were placed in a bag [more discussion in Experiment 2].

Zero-OxTech® oxygen scavengers are designed keeping in mind the significant variation in O₂ absorption rates of O₂ scavengers based upon iron chemical systems and enzymes. Hence, appropriate design of Zero-OxTech® O₂ scavengers is of importance in situations where high O₂ absorption rate is initially required. For preservation of MRA enzymes as per the Zero-OxTech® process, scavengers based upon iron chemical system should be employed. Also, total oxygen absorbing capacity of the Zero-OxTech® oxygen scavengers should be such that resulting oxygen half-life is less than two hours. However, due to significant positioning effects, the Zero-OxTech® oxygen scavengers should be placed either inside the retail trays containing O₂ sensitive products, inside the retail trays as well as in the surrounding gas-impermeable bags, or outside the retail trays contained in the master-bag depending on the oxygen sensitivity of the protein.

2. Packaging Film Structure:

The packaging film structure used in the Zero-OxTech® process shall have ultra-high barrier properties as given in FIG. 3. Different combinations of packaging film structure can be employed to deliver Oxygen Transmission Rate of <10 cc/sq m/24 hr at 23° C. dry and having other properties as listed in FIG. 3. Such packaging film characteristics are desired so Oxygen Absorption Rates is that of first order as in Equation 1, and oxygen scavenger can be designed delivering first-order absorption reaction rate, and delivering a Zero-Oxygen atmosphere, resulting in the “preservation of MRA group of enzymes” as per the Zero-OxTech® process, and to make sure no additional variables are introduced maintaining all constants as per Equation 3.

3. Equipment Design:

In order to maintain the “first order reaction” characteristics of the oxygen-absorption needed for the Zero-OxTech® process as per the Equations 1 and 3, it is very important that the packaging equipment design and equipment configuration should be carefully selected so a specific initial oxygen concentration is achieved in the package, which is needed for the Zero-OxTech® process. The package needs to have the vacuum and gas-flush capability, which shall aid it reducing the initial high oxygen concentration to low levels of less than 10%, however, specific initial oxygen concentration needs to be maintained <5%. Closed system packaging machine/Chamber machine [FIG. 4], Thermoforming/Vacuum skin packaging machine [FIG. 5], MAP tray machine [FIG. 6], OR Open system packaging machine FIG. 7 shall be used to maintain a specific initial oxygen concentration in the package to achieve “first-order” reaction-rate of oxygen absorption so that Zero-Oxygen Atmosphere can be obtained in the package to “PRESERVE MRA GROUP OF ENZYMES” as desired by the Zero-OxTech® process.

### Experiment #2 Shelf-Life Extension of Case-Ready/Retail-Ready/Portion-Cuts Using Zero-OxTech® Process

Introduction:

Zero-OxTech® process is based on the concept to preserve MRA natural enzymes within the protein muscle and also warrants that such preservation of natural enzymes will result in longest shelf-life extension of fresh meats since these natural enzymes are not depleted when the fresh meats are packaged as per the Zero-OxTech® guaranteeing an absolute zero-oxygen atmosphere. The shelf-life extension had been a major concern for the CENTRALIZED MEAT OPERATIONS, where case-ready/portion-cuts/retail-ready meat cuts are made in the centralized locations. Conventional meat operations [FIG. 8] has several steps, where retail-ready/portion-cuts/case-ready meat cuts are made at the local store level, whereas in Centralized Meat Operations retail-ready/portion-cuts/case-ready meat cuts are prepared at the central location [FIG. 9], and Zero-OxTech® process, which is based on the preservation of natural enzymes is desired for centralized meat operations to offer longest shelf-life for centrally prepared meat-cuts.

Background:

Traditionally, once a primal cut of meat has been made, it is placed in a package containing ambient air and the lidding material is fed from a roll and over the tray covering the meat cut. The tray edges are typically sealed to form the finished product. However, since the air allows the meat to become discolored due to the onset of metmyoglobin, the meat normally undergoes vacuum skin packaging in order to maintain freshness and reduce spoilage of the meat cut.

The conventional vacuum packaging process normally does not allow the meat cut to exhibit a deep red pigment desired by retailers and consumers, and contains residual oxygen, there by depleting the natural MRA enzymes within the protein muscle. Subsequently, once these vacuum-packed meat cuts reach the supermarkets or meat distribution centers, the primal cuts are cut into smaller cuts. These smaller cuts are then repackaged or displayed in a case for sale. In a very short time, the meat cuts lose the desired red color and start to brown or otherwise become discolored, losing its aesthetic fresh, healthy appearance and often not sold as a result.

Specifically, meat cuts lose their healthy color due to metmyoglobin (aka browning of meat). Metmyoglobin occurs because of oxidation of deoxymyoglobin, and this chemical reaction of the meat is irreversible. Under a reduced oxygen condition, the rate of the metmyoglobin is high. Transient discoloration can occur in a reduced oxygen environment, because meat muscle possesses a limited enzymatic activity known as metmyoglobin reducing activity (MRA) which converts metmyoglobin back to de-oxymyoglobin However, this process, which can decrease and possibly reverse discoloration, takes several days and is detrimental to centralized meat operations. Furthermore, the MRA is extremely limited and once consumed by the meat cannot be rejuvenated. Zero-OxTech® process is based on creation of absolute zero-oxygen process surrounding the meat and preserves the natural MRA enzymes within the protein muscle.

Centralized packaging of retail meat cuts is gaining in popularity in the food industry due to its economies and the potential to maintain quality, enhance safety, and extend the shelf-life of fresh meat. However, the general requirements to optimize shelf-life of centrally prepared retail-ready meat cuts are slightly different from those needed to extend shelf-life of fresh chilled meat for periods of up to fifteen weeks. Deterioration of chilled meats primarily takes place at the cut or uncut muscle surface. In long term storage at a centralized packaging and storage operation, primal cuts are placed in an atmosphere saturated with carbon dioxide (CO₂) (100%) which contains very low residual oxygen (O₂), and these primal cuts stored at −1.5+/−0.5° C./28° F.

At the end of required storage, meat is removed and fabricated into retail or food service cuts. New fresh surfaces are created in the process, revitalizing the appearance of the meat cuts; and when the new surfaces of the meat cuts are prepared for retail display the normal expectation is a further four days of shelf-life. Depending on the variability of the meat species, the shelf-life is usually limited by development of undesirable organoleptic changes, where defects in color are usually independent of the microbial presence. The latter has a lactic acid bacterial population, which maximizes under storage conditions at levels about 10⁸ cfu/cm² well before the shelf-life expiration.

However, with centralized distribution of retail ready fresh meat, circumstances and storage requirements are different. The wholesale storage period following initial packaging of the retail cuts is in the range of 20-30 days and prepared products must withstand the rigor of retail display for up to two days thereafter without further manipulation of the contents of the package. Retail packages are simply moved from their storage container (usually a unit or over-wrap containing a modified atmosphere) to retail display where desirable meat color develops upon exposure to air. The present commercial centralized meat operations only provide one to two weeks of shelf-life. Whereas, in North America, total shelf-life of several weeks (i.e. at least greater than four weeks) is desired because of distant markets and intent of North American meat industry to export to distant countries. Hence, the goal is to extend the shelf-life of retail-ready meat cuts, which is only possible with the Zero-OxTech® process, which guarantees the preservation of the natural enzymes and results in the longest extended shelf-life of centrally prepared meat-cuts.

Prior Art:

Several approaches has been taken to extend the shelf-life of meat. The basic approach is to package meat cuts with an inert gas atmosphere after the meat has been shipped from a processing facility to a retail outlet. Thereafter, when the retail outlet receives the packaged meat, the inert gas within the package is replaced with an oxygen-containing atmosphere. However, this approach only offers up to 4 days of shelf-life during retail-display.

One example of such a packaging system is depicted in U.S. Pat. No. 4,055,672 issued in 1977. The '672 patent provides for a system in which a meat product is packaged with one of the package walls formed from a gas impermeable material and another package wall formed as an inner gas permeable layer and an outer gas impermeable layer. The meat cut is initially packaged in an inert gas atmosphere which is maintained within the package by the package walls including the outer gas impermeable wall layer. If the outer gas impermeable layer is removed, this enables the oxygen-containing ambient air to flow into the package through the gas permeable layer. However, the '672 patent allows the meat to deteriorate after the impermeable layer has been removed, unless an additional impermeable layer is added. Nevertheless, placing a gas impermeable film layer over a gas permeable film layer is expensive to produce and difficult to seal to a container.

Another example of packaging containing an inert gas atmosphere is depicted in U.S. Pat. No. 6,302,324 issued in 2001. The '324 patent provides for packaging a food product in a receptacle containing an inert gas atmosphere and sealing a film to the receptacle. The receptacle includes a sealing flange and a tab portion extending from the sealing flange to which the film is sealed. The tab and the film are removed from the package to form an opening between the film and the receptacle when the food product is ready to be displayed to consumers. An atmosphere exchange operation is carried out through the opening, by inserting a nozzle through the opening and introducing an oxygen-containing gas into the receptacle cavity through the opening. The inert gas atmosphere initially contained within the receptacle is exhausted through the opening and the nozzle is withdrawn from the opening. The opening is closed by sealing the film to the receptacle. The '324 patent allows an inert gas atmosphere within the interior of the package to be easily and quickly replaced with an oxygen-containing atmosphere.

U.S. Pat. No. 6,408,598 also provides for a modified atmosphere packaging process including the steps of providing a tray, providing an upper film which includes a sealant layer which is sealable to the tray, orienting the film to an orientation ratio of from about 6.0:1 to about 16.0:1 positioning, a high profile product on the tray, extending the upper film above the tray and product, drawing the upper film into a concavity by differential pressure, maintaining the concave shape of the upper film while heating the film, removing gases from the space between the upper film and the tray and product, introducing a desirable gas into the space, releasing the upper film such that it shrinks toward the product and the tray while the desirable gas is retained within the space preventing close contact of the film with the lowermost portions of the product and sealing the upper film to the flange of the tray, wherein at least the step of heating the film shrinks the film, thereby tensioning it onto and across the underlying product.

Another patent for extending the shelf-life of meat has been depicted in the process for pre-packing fresh meat seen in U.S. Pat. No. 4,683,139. The '139 patent describes a process where the meat is treated with an aqueous solution containing three active components, namely phosphate compounds, a reducing agent and a sequestering agent; and then packaging the meat in a controlled gaseous atmosphere containing from about 20% to 80% carbon dioxide and from about 2% to 30% oxygen, with the balance being nitrogen. Specifically, the process includes (1) placing at least one pork chop on each of a plurality of semi-rigid trays; (2) placing a gaseous mixture over and around the chops on each of the trays; (3) sealing the trays with a gas permeable film; (4) placing a plurality of the trays on a thermoformed tray; and (5) covering and sealing the thermoformed tray with a gas impermeable film.

However, the '130 patent concentrates on the centralized pre-packing of fresh meats at the meat packing plant prior to shipment to the point of storage or retail sale. Further, the '139 patent fails to include 100% nitrogen gas filling a master bag before the placement of the tray.

Other examples of inventions desiring to extend the shelf-life of food products are U.S. Pat. Nos. 5,527,105 and 5,705,215 issued to Riach, Jr. The '105 and '215 patents provide for a magnetic method for extending the shelf-life of food products wherein magnetic strips, matting formed from the strips and pads having magnetic north sides and magnetic south sides. Here, the negative magnetic north sides of the magnetic strips or pads are arranged to impinge on the fresh food products stored in a low-temperature environment. However, the '105 and '215 patents achieve a wetter condition thereby establishing a longer shelf-life condition for foods which are stored in a combined environment to include a north magnetic field and a selected low temperature.

Another example of a shelf-life extender for food use is depicted in U.S. Pat. No. 5,985,303 issued to Okada in 1999. The '303 shelf-life extender incorporates an isothiocyanic acid compound being supported on a matrix, where the compound is packaged in synthetic resin film or non-woven fabric. However, the '303 patent concentrates on acidic chemical compounds and gelling agents as opposed to integrating a zero oxygen packaging system as described by the present invention.

U.S. Pat. No. 6,153,241 describes another method and a package for extending the shelf-life of a food. Specifically, the method of achieving an extended shelf life for a food includes enclosing the food in a discrete container having a first and a second container position, treating the food in the discrete container with heat in a treatment chamber while the container maintains the first container position and raising the container to the second container position under which the container is distributed, sold or used. However, contrary to the present invention, the '241 patent describes a method of heat treating a pumpable food carried out in a treatment chamber.

U.S. Pat. No. 6,183,790 to Delducca et al and U.S. Pat. No. 6,666,988 to Carr et al utilize an external oxygen accelerator to activate an oxygen scavenger to reduce the oxygen concentration to 500 parts-per-million (ppm) within 90 minutes. However, even at these low oxygen levels metmyoglobin formation remains very high (See FIG. 1). This stems from the fact that transient discoloration occurs because of limited metmyoglobin reducing activity (MRA) with the meat muscle, and these patents fail to address this process.

U.S. Pat. No. 6,269,946 to Colombo includes use of a meat tray over-wrapped with a gas permeable film. This patent uses metal chloride inside a meat tray to combine with water and acid to produce chlorine dioxide to help preserve meat cuts packaged therein. The disclosed invention also claims oxygen absorbers packaged within a barrier bag, but the patent fails to discuss the importance and advantages of sealing oxygen scavengers inside the meat tray or the need to quickly obtain a zero-oxygen gas environment for long-term cold storage of meat cuts both within the meat tray and the barrier (e.g. master) bag. The patent only provides for very low oxygen environment of about less than 0.05% volume of oxygen and does not attain zero oxygen levels. Further, the meat tray adds a receptacle for injecting carbon dioxide into the meat tray and does not recommend a nitrogen-rich gas environment for storage, instead favoring carbon dioxide. Carbon dioxide is not preferred for several reasons.

Other U.S. patents and publications (U.S. Pat. Nos. 6,230,883, 6,447,826, 6,586,651, 6,592,919) recommend using an atmospheric mixture containing carbon dioxide or discuss methods to create an atmosphere of carbon dioxide. However, in these inventions, although carbon dioxide has anti-microbial activity, solubility increases at low temperature and it is absorbed into the meat cuts, and after long storage the meat starts to discolor from the inside out. For this reason, carbon dioxide is only successful for long-term storage of primal or sub-primal meat cuts or uncut carcasses. However, for retail ready cuts, use of carbon dioxide is detrimental to the meat color if long-shelf life of case-meat is desired. Solublization of carbon dioxide into the meat prevents and/or delays meat cuts from re-blooming when master bags containing retail meat cuts are opened and the meat exposed to air.

In other systems utilizing activated oxygen scavengers as mentioned by Delducca et al and Carr et al, the presence of carbon dioxide hinders the rate of oxygen absorption by oxygen scavengers due to formation of carboxylic acid (carbon dioxide reacting with residual oxygen), hence the lowest oxygen concentrations obtained with these systems is 500 ppm within 90 minutes, and other issues regarding transient meat discoloration remain unsolved, but does not focus on absolute zero-oxygen atmosphere, which is the key behind preservation of natural meat enzymes as invented and desired by the Zero-OxTech® process.

Present commercial centralized meat operations employ master packaging in which three or more trays, each containing retail-ready meat cuts, are placed in a gas-impermeable master bag. However, residual oxygen may be present inside the packages due to the entrapment of oxygen during controlled atmosphere packaging (CAP). Specifically, the residual oxygen may be present due to any one of the following factors: (1) insufficient oxygen evacuation; (2) insufficient flushing times during CAP-machine operations; (3) use of an improper ratio of meat-mass to package atmosphere resulting in dead space in the master bag; (4) oxygen entrapment in the retail trays themselves, in absorbent pads or under the meat cut; (5) oxygen ingress through seams of a film used to over-wrap a master pack; (6) film defects; or (7) oxygen release from meat muscle. Since some of these factors are inevitable in commercial meat packaging operations, the plain use of master packaging has found limited application in commercial centralized meat operations. Therefore, a system is needed to reduce the oxygen concentration in a relatively short period of time in order to restore the metmyoglobin reducing activity.

Previously issued patents and prior art procedures reduce the oxygen concentration to at best 500 ppm within 90 minutes. These processes can result in some extension of shelf life of case-ready meat cuts for retail sale, however these oxygen concentrations still lead to transient meat disclosure, and result in the depletion of the natural enzymes within the meat-muscles, which is the key distinct feature of Zero-OxTech® process. For meat-packaging implementing national and international centralized meat packing operations, extremely long shelf life in the range of 8-10 weeks is desired. This long of a shelf-life can only be obtained if the transient meat discoloration can be avoided, and natural meat enzymes are preserved. Consequently, premature temporary discoloration limits the advantages of centrally packaged retail ready meat cuts using current oxygen depleted master packaging methods because a zero-oxygen storage environment is not attained and natural meat enzymes responsible for recovering discoloration and providing extended shelf-life are not preserved.

Discoloration is also dependent on the specific muscle packaged since tissue vary in capacity to withstand low oxygen concentrations (<500 ppm). Centrally prepared beefsteaks and ground beef packaged under controlled atmospheres are shown to be susceptible to very low oxygen concentrations. Beef muscle with high color stability are least susceptible to metmyoglobin formation if the atmosphere is maintained at <600 ppm O₂ at temperatures <0° C. However, beef with poor stability is highly susceptible to metmyoglobin formation even at very low O₂ concentrations and subzero temperatures, and these cuts require a zero-storage environment for long-term storage.

If the enzymes causing MRA are retained in the meat, longer shelf life of meat cuts is possible, as in the Zero-OxTech® process. To accomplish this, the oxygen concentration in the master-bags used to ship meat from a central meat operation containing groups of meat trays must be zero, as discussed and invented by the Zero-OxTech® process. Under zero-oxygen concentration, meat color will go to the de-ox state and will come back to ox-state with the master-bags containing trays are opened and exposed to atmosphere. By doing this procedure, the enzymes causing MRA are retained and the meat does not go through a transient discoloration and long shelf-lives can be attained. The present invention has been developed to alleviate the above-identified drawbacks and provide further benefits to the meat distribution centers, supermarkets and the consumer.

The goal of the Zero-OxTech® invention is to provide meat packers with an integrated packaging system that incorporates oxygen scavengers along with automatic formation of master-bags to fit the size of meat-trays, family size or multi-individual trays, and gas-flushing and sealing. The packaging system reduces the oxygen concentration to 0 ppm within a short period of time after pack closure.

### SUMMARY OF THE INVENTION: ZERO-OXTECH®

The present invention in its several disclosed embodiments alleviates the drawbacks described above with respect to traditional meat packaging and incorporates several additionally beneficial features. The process of packaging meat, namely retail-ready meat, is known in the prior art. Disclosed herein is a packaging system and method of same developed to prevent meat discoloration of prepared fresh meat cuts, such as beef, pork, lamb, and chicken. Specifically, different packaging configurations use self-activated oxygen scavengers and structures to extend the shelf life of fresh meat cuts by attaining a zero oxygen-packaged environment.

When fresh meat is exposed to oxygen, two effects normally occur. First, bacteria begin to grow and subsequently the fresh meat color disappears. By eliminating exposing the meat to oxygen, the chances of reducing bacteria and extending the fresh meat color improve dramatically. As a result, the present invention effectively removes oxygen very rapidly from a sealed package thereby increasing the shelf-life of the meat up to 12 weeks or more for different meat types.

The disclosed packaging system extends the shelf-life of centrally prepared retail-ready meat cuts by restoring metmyoglobin reducing activity of the meat-muscle through zero oxygen packaging. This achieves extremely long shelf-life for storage of retail-ready meat cuts. A retail-ready meat cut is placed in a tray having an activated oxygen scavenger based upon an iron chemical system and an absorbent pad. Several of these trays are placed in a master bag that is filled with a high nitrogen gas mixture and sealed. Several different combinations of placing scavengers (based upon iron chemical systems) and optimization of the oxygen scavenging capacity in each tray are achieved.

The tray or the master bag containing optimum oxygen scavenging capacity results in 0.6-2.0 hour half-life for oxygen in the master bag (depending upon the initial oxygen concentration and meat-type) and is the one desired for centrally prepared retail-ready meat cuts. Such a packaging system under 100% nitrogen atmosphere resulted in at least a ten week storage life for centrally prepared meat cuts, such as beef tender loin steaks, with a subsequent display life of at least three days.

Thus, the use of an activated oxygen scavenger and an absorbent pad inside a master bag having 100% nitrogen introduced therein provides a significant increase in profits by reducing spoilage. By reducing the partial pressure of oxygen to zero ppm in the master bags, the growth of the aerobic spoilage and pathogenic microorganisms is inhibited thereby extending the storage and display life of retail-ready fresh meat packages. Additionally, this process preserves the vivid, bright cherry red color of red meats, whereby longer shelf life and better looking meat products translate into higher sales and higher profits. Moreover, the master package will reduce purge due to temperature changes and will actually enhance the natural aging process producing more flavorful and tender cuts of fresh meat.

Another advantage of the present invention is that a retailer is capable of unpackaging a days' supply of fresh meat cuts at a time. The master package is protected from oxygen exposure until the seal is released and the individual packages are placed in the retail case. The shelf life clock does not begin ticking until the fresh meat is placed in the retail case. For central packaging operations, by utilizing the master packages, the shrinking of meat cuts due to handling, transportation and temperature fluctuations is greatly reduced to virtually zero shrinkage.

The main advantage of the invention is the zero-oxygen system gas environment in the master bag stops the formation of metmyoglobin, the agent that causes fresh meat to become discolored. By stopping metmyoglobins formation, the metmyoglobin reducing activity (MRA) of the meat muscle is retained. Because the oxygen concentration in the master bag is zero ppm, metmyoglobin cannot form and the discoloration process never occurs. Further, under the zero-oxygen system, only lactic acid and other slow growing anaerobic bacteria will grow; and the growth of faster growing aerobic bacteria causing rapid spoilage is restricted.

Shelf-life in the retail case is increased by one to seven additional days, depending upon the type of meat cut. The present packaging system preserves the enzymatic activities of meat-muscle that maintains the bright cherry red color of each meat cut, the retail display life of the meat is extended dramatically. The addition of carbon monoxide as part of the gas mixture environment also helps preserve the reddish color of the meat as a layer of carbon monoxymyoglobin is formed on the meat surface,

The apparatus used in the invention will automatically package meat trays into a single master bag containing oxygen scavengers with appropriate oxygen absorption capacity to reduce the half-life of oxygen inside the master bags and meat packages to between 0.6 and 2.0 hours. The master bags are formed around the meat trays and the ambient air is flushed from the bag. The bag is then injected with the desired gas mixture environment that is preferably 100% nitrogen or nitrogen rich (>50%) with the balance a mixture of other gases, preferably carbon monoxide and carbon dioxide. Some small quantity of carbon monoxide (≥0.1%) is preferred. The master bags can then be stored for several weeks at freezing or below freezing temperatures (28°-32° F.) until needed for placing into a retail display for several days before meat discoloration occurs.

### DETAILED DESCRIPTION OF THE PREFERRED EMBODIMENTS OF ZERO-OXTECH® PROCESS

As required, detailed embodiments of the present invention are disclosed herein; however, it is to be understood that the disclosed embodiment(s) are merely exemplary of the invention that may be embodied in various and alternative forms. Specific structural and functional details disclosed herein are not to be interpreted as limiting, but merely as a basis for the claims and as a representative basis for teaching one skilled in the art to variously employ the present invention. Further, the particular materials and amounts thereof, as well as other conditions and details, recited in these examples should not be used to unduly limit this invention.

The present invention in its several disclosed embodiments alleviates the drawbacks described above with respect to traditional meat packaging and incorporates several additionally beneficial features. The process of packaging meat, namely retail-ready meat, is known in the prior art. Disclosed herein is a packaging system and method of the same developed to prevent meat discoloration of prepared fresh meat cuts and to provide extended shelf-life of meat-cuts, such as beef, pork, lamb, and chicken. Specifically, different packaging configurations of components of the system use self-activated oxygen scavengers and structures to extend the shelf life of fresh meat cuts. Zero-OxTech® process has the following key-components:

### Zero-OxTech® Oxygen Scavengers

Oxygen scavengers based on iron chemical systems were employed for the Zero-OxTech® process. A sachet placed within the packaging bag contains chemical granules ranging from 0.001 mm to 1.5 mm in diameter. The half-life of oxygen in a bag containing these oxygen scavengers was in the range of 30 to 1500 minutes, with the quantity of oxygen absorption material ranging from 1 gram to 300 grams. The oxygen absorption material was placed in a package, which was either laminated or unlaminated with porosity levels ranging from 20 to 120 gurly a second, and an active surface area of 4 to 64 square inches. The preferred material for the bag is tyvek. The scavengers are typically formed from iron (<25%, preferably 15-20%), carbon (<35%, preferably 20-30%), vermiculite (<20%, preferably 10-15%), and de-ionized water (<10%, preferably 5%), salt [NaCl] (<10%, preferably 5%). A small amount (<10%) of zeolites can also be added for increased oxygen absorption rates. Oxygen scavengers can also be based on magnesium, copper, and enzymes. The oxygen scavengers are activated upon exposure to air and/or oxygen in an atmosphere greater than 60% relative humidity, and work under a temperature range of 28° to 45° F.

### Meat Characteristics

The meat can be of any type such as pork, lamb, beef, veal, chicken, fish, turkey, venison, or any other meat type. In the actual meats studied developing the invention, meats used included beef, veal, pork, lamb, and chicken. The cuts used were primal and/or sub-primal, and the grades of fresh meat cuts were prime, choice, and/or select. The meats included both boned and boneless cuts, and the size of fresh cut meat product was in the range of 1 to 5 lbs. The meat carcass was cooled either though blast cooling and/or cold room storage, with a cooling temperature of between 5° to 40° F. The time between slaughter and packaging was in the range of one day to 28 days. Packaging temperatures were less than 40° F.

### Zero-OxTech® Retail Tray Characteristics

The retail tray composition was of plastic and/or polystyrene/foam and/or combination of both. The inherent oxygen content of the retail tray was in the range of 10 to 23,000 ppm. The surface of the retail tray exhibited either a grid or ridged pattern, or a flat surface upon which to place the fresh meat product. The retail tray cover was either lidded or over-wrapped. The retail tray surface area was in the range of 15,000 to 325,000 square mm. A moisture absorbent pad was either placed in the retail tray before the fresh meat product or was not included. The oxygen scavenger pads were placed in the retail tray or exterior to the retail tray.

The retail tray overwrap used has an oxygen permeability in the range of 3,000 to 10,000 cc of oxygen per square meter per 24 hours at 73° F. and 70% relative humidity. Additional atmospheric permeability of the retail tray overwrap consisted of additional ambient atmosphere flow with multiple holes, each having a diameter of less than 5 mm, punched through the overwrap or a single needle hole with a diameter of less than 5 mm.

### Zero-OxTech® Bag/Packaging Film Characteristic

The meat trays containing different meat cuts in different numbers (one to six retail trays) are placed in a master bag possessing good seal strength or single meat cuts can be placed in the bag having the packaging film characteristics as FIG. 3. The bag possesses good seal strength with either a foil lining or an ethyl vinyl alcohol (EVOH) lining. The oxygen permeability of the master bag was less than 13 cc of oxygen per square meter per 24 hours at 73° F. and 70% relative humidity. The master bag could be prepared by gas-flushed with different gas-compositions and sealed. Alternatively, meat cuts can be placed in the bag and vacuumed with no gas flush. FIG. 3 gives key packaging film structure to be used with the Zero-OxTech® process.

### Zero-OxTech® Process Vacuum or Vacuum+Gas-Flush or Gas Atmospheres to be Created in the Master-Bag

The Zero-OxTech® process can either be used with vacuum or with the modified atmosphere characteristics composed of different gas mixtures of carbon dioxide, carbon monoxide, and nitrogen/inert gas. Typical gas mixtures either consisted of 100% nitrogen and/or any inert gas or contained 100% carbon dioxide or different percentages of gases generally in the concentrations of <1% carbon monoxide, <40% carbon dioxide, and the balance either nitrogen and/or some other inert gas. The oxygen scavengers of different characteristics were placed in the master bags or in the retail trays or both. The residual oxygen content in the master bag after gas flushing using single or multiple cycles was less than 6%. The storage temperature of the master bags was less than 40° F., and the master bags were stored for up to 15 weeks. Similarly, meat cuts can be placed in Zero-OxTech® bags which were packaged only with vacuum without any gas-flush.

Zero-OxTech® Packaging Equipment:

Zero-OxTech® process can be used utilizing either Closed system packaging equipment/chamber packaging machine [FIG. 4], or Vacuum skin packaging machine [FIG. 5], or Modified Atmosphere Tray Packaging Machine [FIG. 6], or Open system packaging machine [FIG. 7].

For experiment #2, several meats cuts, whether retail-ready/portion-cuts/case-ready cuts as well as primal-meat were packaged using different machines [FIG. 4-7] as per the Zero-OxTech® process: Zero-OxTech® oxygen-scavenger designed to deliver absolute Zero PPM within 24 hours of pack-closure; Zero-OxTech® gas combinations [CO₂:N₂=30:70; CO₂:N₂:CO=30:69.6:0.4]; Zero-OxTech® vacuum-package; Zero-OxTech® MAP-tray with gas-flush; Zero-OxTech® MAP tray with vacuum; Zero-OxTech® bags with single and/or multiple over-wrapped foam trays using open and closed packaging system; FIG. 10-13 presents the process flow for packaging different meat cuts as well as primal-cuts using different packaging machines as per the Zero-OxTech® process, and FIGS. 14-16 depicts illustrative Zero-OxTech® package-formats using different Zero-OxTech® packaging process. FIG. 17 depicts shelf-life extension process-operation of beef, pork & lamb using Zero-OxTech® process.

### Experiment #2 Display and Sampling of Primal-Cuts and Retail-Trays Containing Meat-Cuts

Upon removal from primary storage at weekly intervals, and on day 0 of retail display, each package was removed and Primal-cuts and retail trays containing meat cuts were placed in the center of the display shelf. The displayed meat cuts were examined for discoloration, retail acceptability, off odor intensity, and odor acceptability, and odor description for every 24 hours for up to 15 days. A similar procedure was repeated for all storage intervals for up to 15 weeks.

### Visual Assessment of Primal and Meat Cuts

A five-member panel was used for the subjective evaluation of the meat cuts. Surface discoloration was evaluated using a seven-point descriptive scale: 1=0% (none), 2=1-10%, 3=11-25%, 4=26-50%, 5=51-75%, 6=76-99%, 7=100%. Retail appearance was assessed on a seven-point hedonic scale: 1=Extremely undesirable, 2=undesirable, 3=Slightly undesirable, 4=Neither desirable nor undesirable, 5=Slightly undesirable, 6=Desirable, and 7=Extremely desirable.

### Odor Assessment of Primal and Meat Cuts

A five-member panel was used for odor assessment. Off odor intensity scores were assessed using a four-point descriptive scale: 1=No off odor, 2=Slight off odor, 3=Moderate off odor, 4=Prevalent off odor. Odor acceptability scores were assessed using a five-point scale: 1=Acceptable, 2=Slightly acceptable, 3=Neither acceptable no unacceptable, 4=Slightly unacceptable, 5=Unacceptable.

### Microbial Analysis

A 10 cm² sample was obtained at each sampling time (on day 0 and last day of each storage interval) from each meat cut using a sterile cork borer. The sample was the placed into a stomacher bag with 10 mL of 0.1% peptone solution and was massaged for 120 seconds using a commercial stomacher, yielding a dilution of 10°. The homogentate was further diluted 10-, 100-, and 10,000-, and 100,000-fold, after which 0.1 mL volumes of undiluted homogenate. Each dilution prepared was spread on duplicate plates of All Purpose Tween (APT). The plates were then incubated aerobically for 3 days at 25° C. The micro flora was determined from plates bearing 20-200 colonies.

### Results Summary

The oxygen concentration was 0 ppm (zero) after 24 hours of storage and was 0 ppm throughout the storage period of up to 15 weeks for all packaging configurations as per the Zero-OxTech®. Based on sensory and microbial analysis:

1) beef cuts were acceptable for 10 weeks storage plus 10 days at the retail display for all packaging configurations,

2) pork chops were acceptable for 15 weeks during storage plus 15 days at the retail display,

3) lamb chops were acceptable for 10 weeks during storage plus 12 days at the retail display, and

4) chicken pieces were acceptable for up to 4 weeks during storage plus 15 days at the retail display.

Demonstrated Principles:

1. Zero-OxTech® process preserves the MRA enzymes within the protein muscles by reducing the oxygen to absolute zero ppm within a few hours of sealing the package.

2. Zero-OxTech® process designed oxygen scavengers provides single-order absorption rate and hence, an absolute zero-oxygen ppm atmosphere is guaranteed. Zero-OxTech® process also utilizes the packaging equipment as per the Zero-OxTech® process to deliver a specific initial oxygen concentration so the single-order oxygen absorption rate is obtained.

3. Pre-treating the “Zero-OxTech® process oxygen scavengers” by moisture causes faster activation.

4. Zero-OxTech® process oxygen scavengers based on an iron chemical system will be effectively utilized to reduce the oxygen concentration in the Zero-OxTech® process bag.

5. Zero-OxTech® process is dependent specifically to deliver a specific oxygen half-life and hence, will be dependent upon the initial oxygen concentration in the package and the ambient temperature. Therefore, all components of Zero-OxTech® process shall be customized for each specific packaging configuration.

6. Zero-OxTech® process, where mother-bag houses single or several meat trays, is affected by the permeability of packaging films surrounding the tray inside the mother-bag, which have very high oxygen ingress rate and is significantly reduced at sub-zero temperatures, hence this film acts as an oxygen barrier, hence, pin-holes will be needed on packaging films surrounding the meat-trays in the mother-bag to prevent entrapment of oxygen within the tray.

8. Zero-OxTech® process provides shelf-life extension of poultry can be obtained with the current invention with or without treatment of PAA [peracetic acid] or any other anti-microbials in the poultry processing lines, which is desired for organic poultry, and using different Zero-OxTech® packaging formats, thereby, Zero-OxTech® process has the capability to provide extended shelf-life for organic poultry without any anti-microbial chemical treatment.

Included within the scope of the present invention and the abovementioned examples are compositions, comprising various combinations of these substances and materials. Aspects of the present invention have been described by way of example only and it should be appreciated that modifications and additions may be made thereto without departing from the scope thereof.

### INDUSTRIAL APPLICABILITY

The present invention finds specific industrial applicability in the centralized meat distribution and retail industries. The Zero-OxTech® process with its components disclosed herein used to package meat cuts achieves zero oxygen packaging in a central packaging facility for master bag storage and retail display. The storage and display times are significantly increased using the components of Zero-OxTech® process for all proteins due to preservation of natural enzymes within the protein.

### DESCRIPTION OF THE DRAWINGS

The objects and features of the invention will become more readily understood from the following detailed description and appended claims when read in conjunction with the accompanying drawings in which like numerals represent like elements and in which:

FIG. 1 depicts different myoglobin states of the protein-muscle and MRA enzymes, which can reduce the met-myoglobin to de-oxymyoglobin;

FIG. 2 is a x-y graph depicting the influence of oxygen concentration on three chemical states of myoglobin;

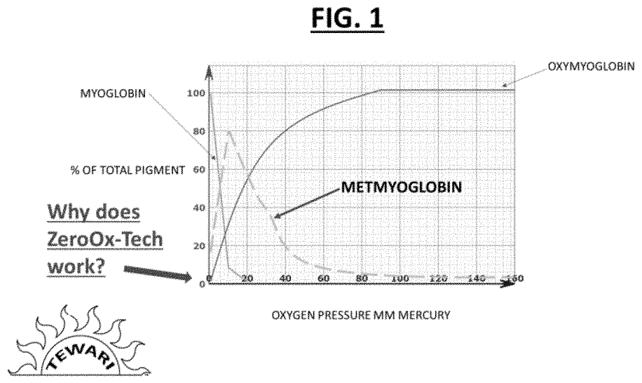

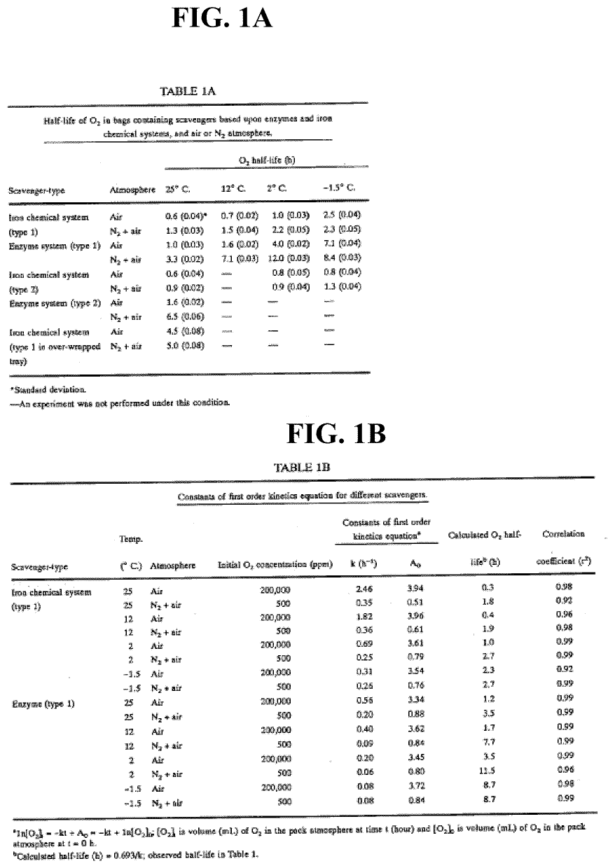

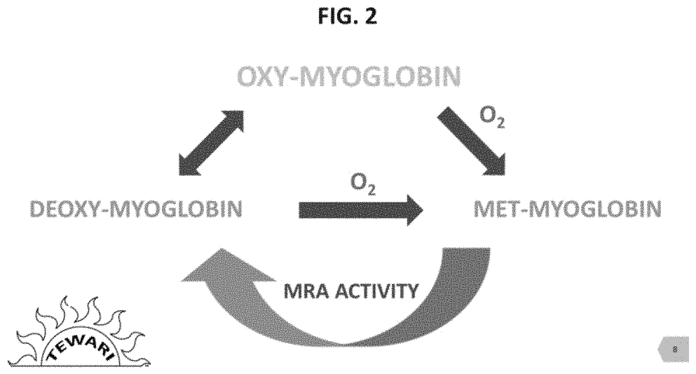

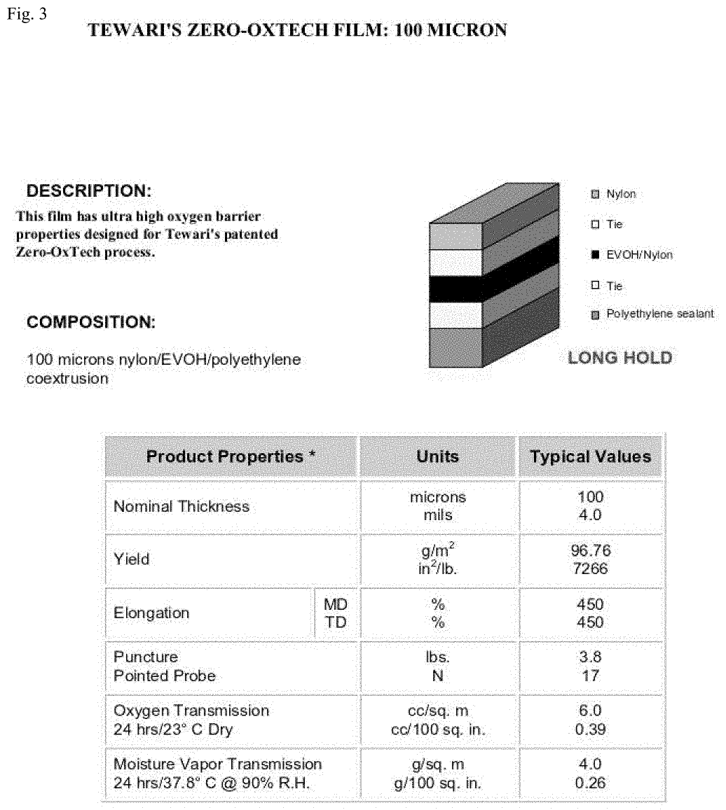

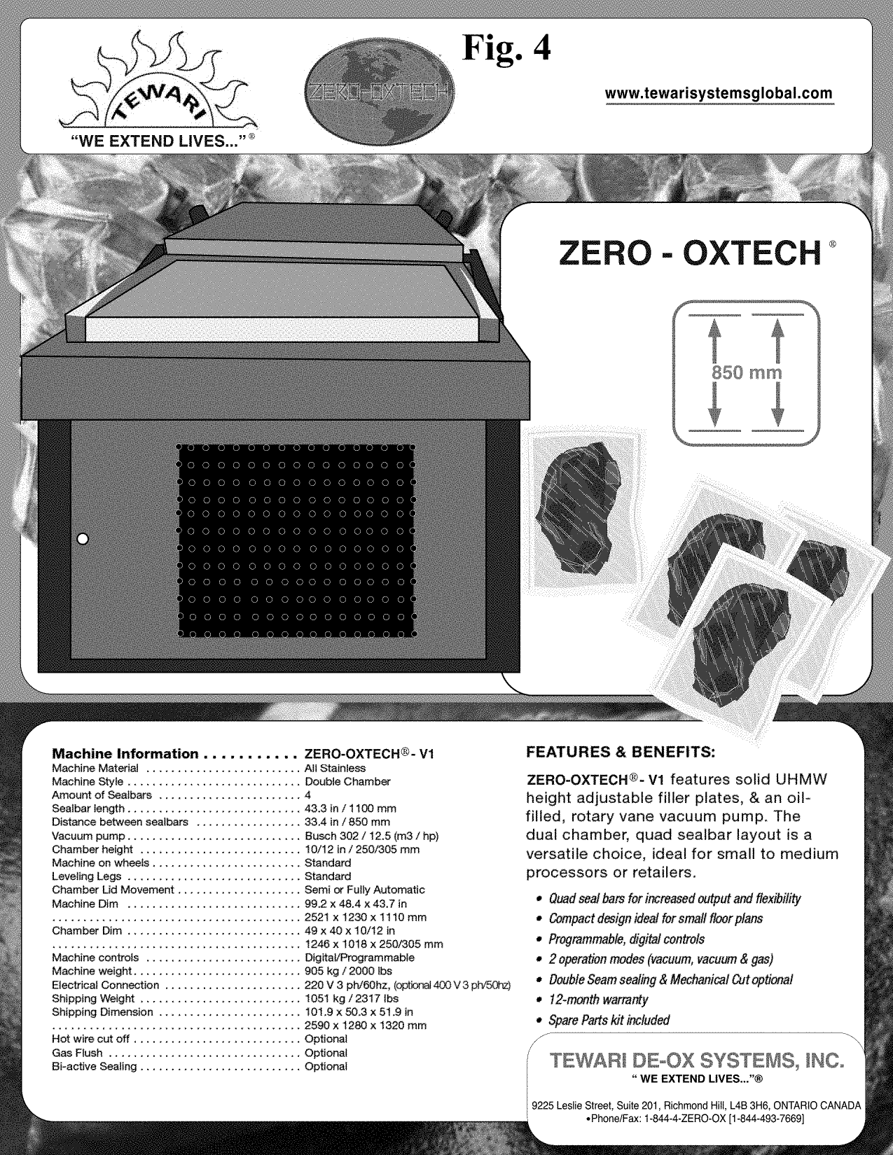

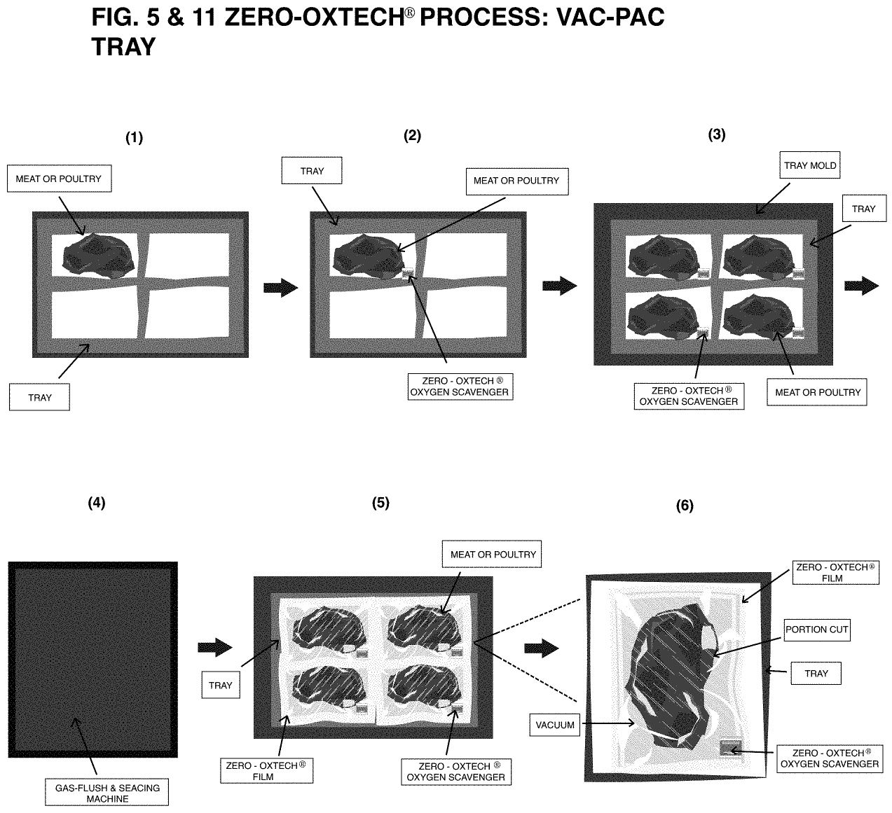

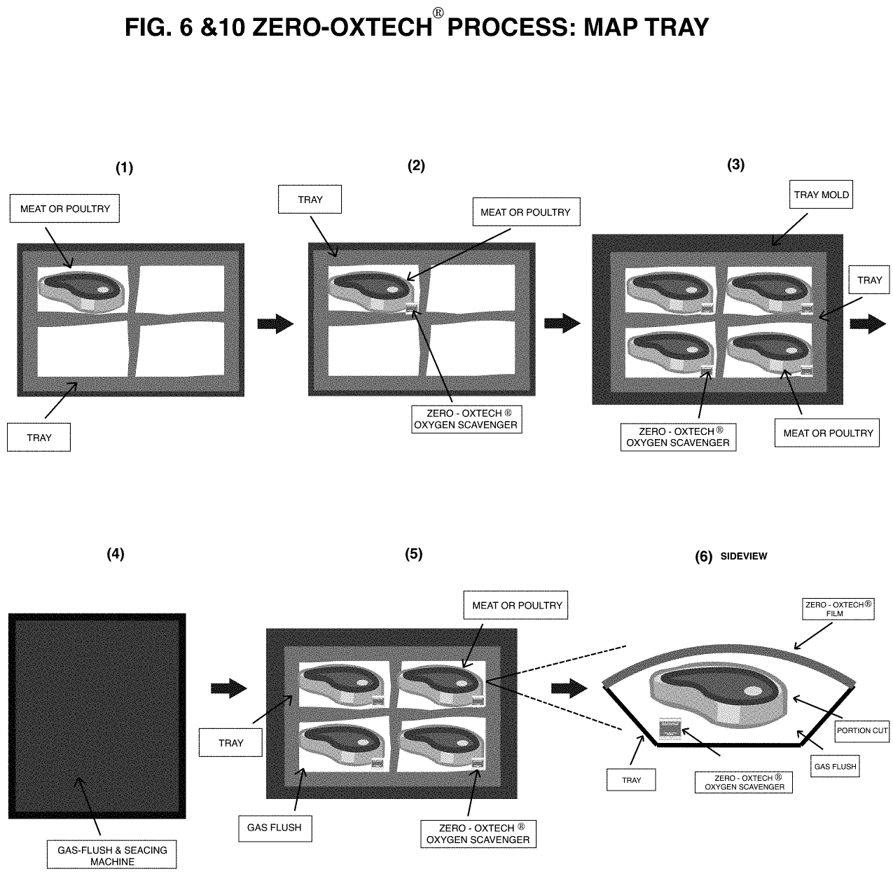

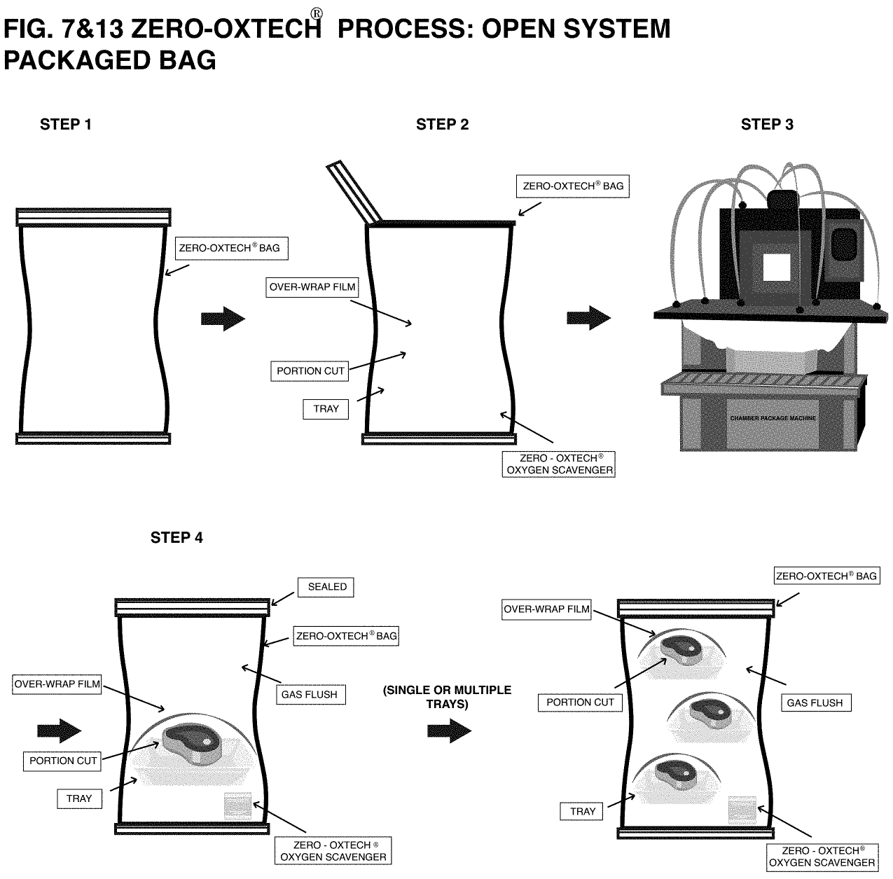

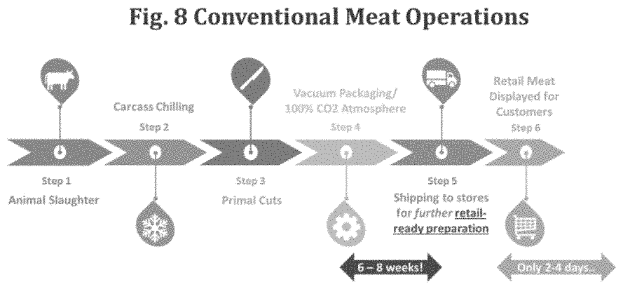

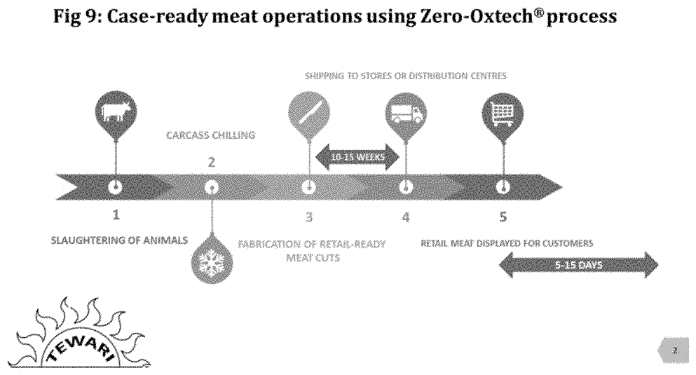

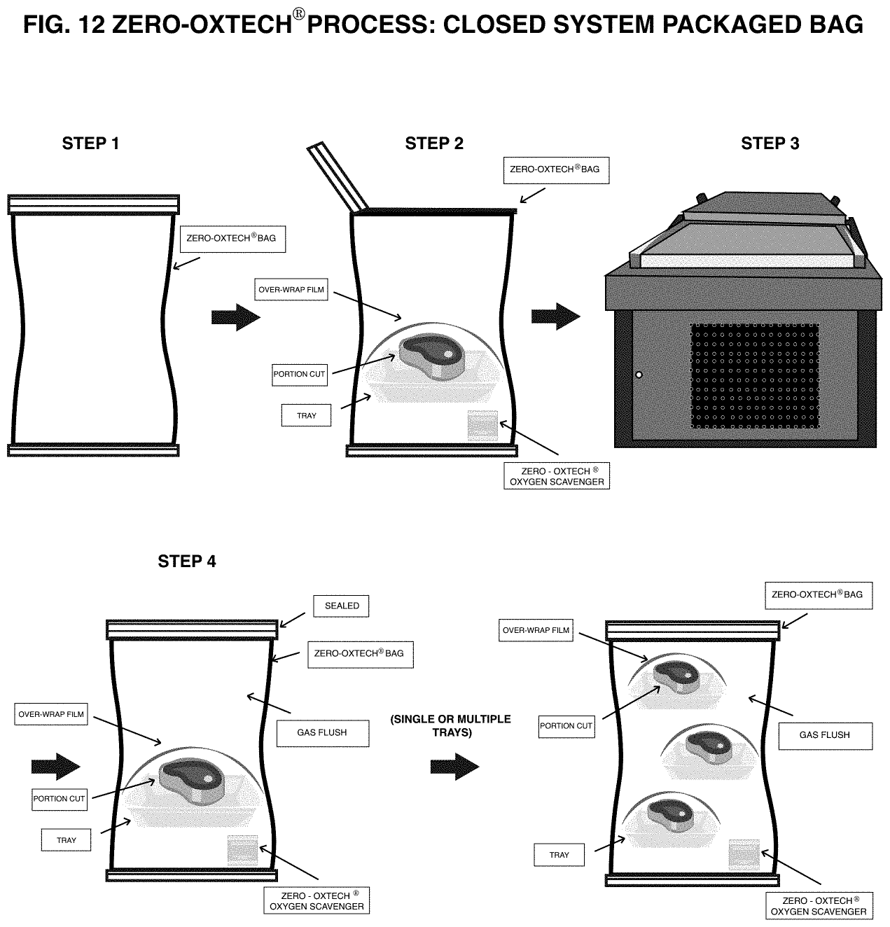

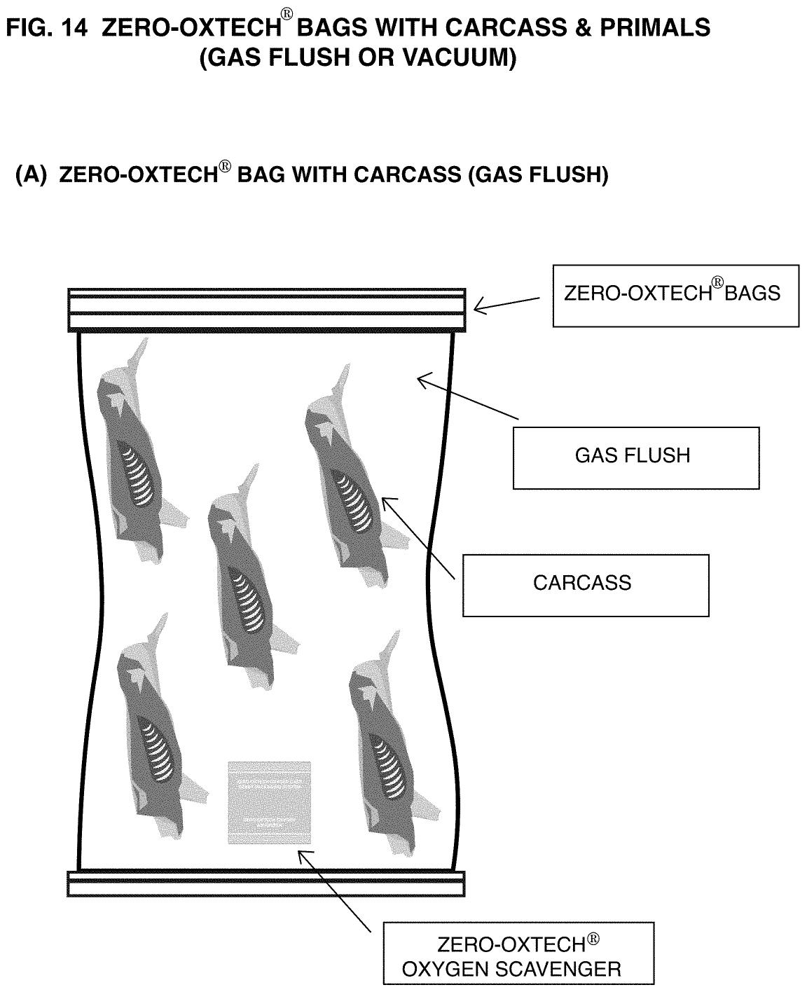

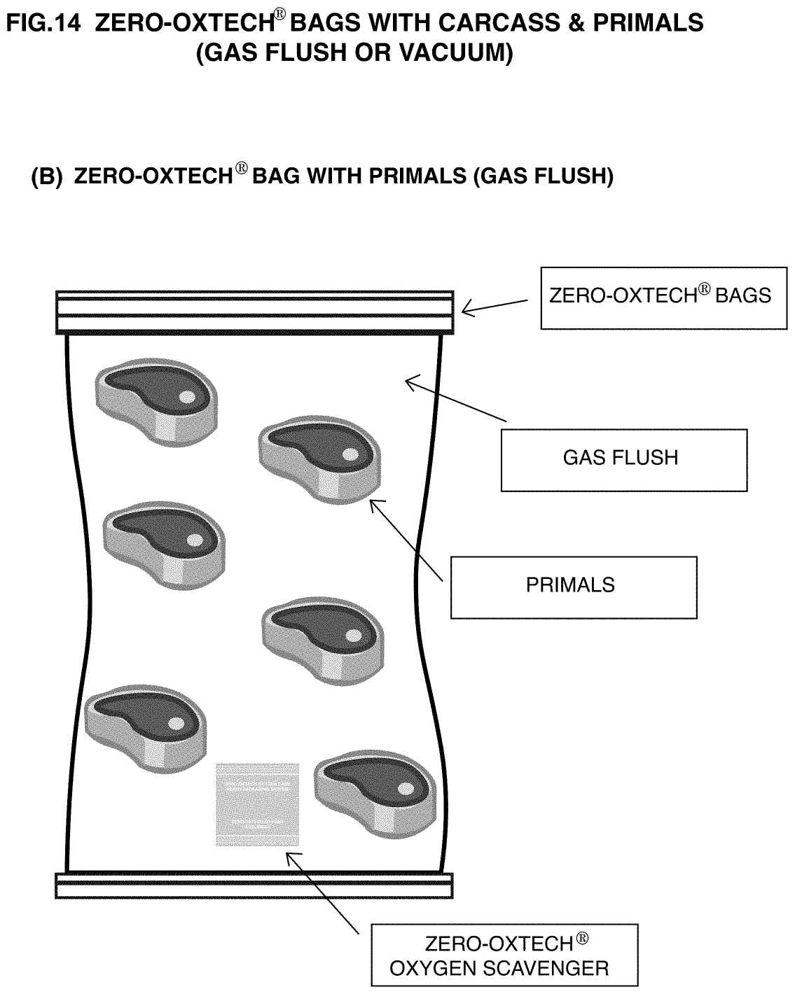

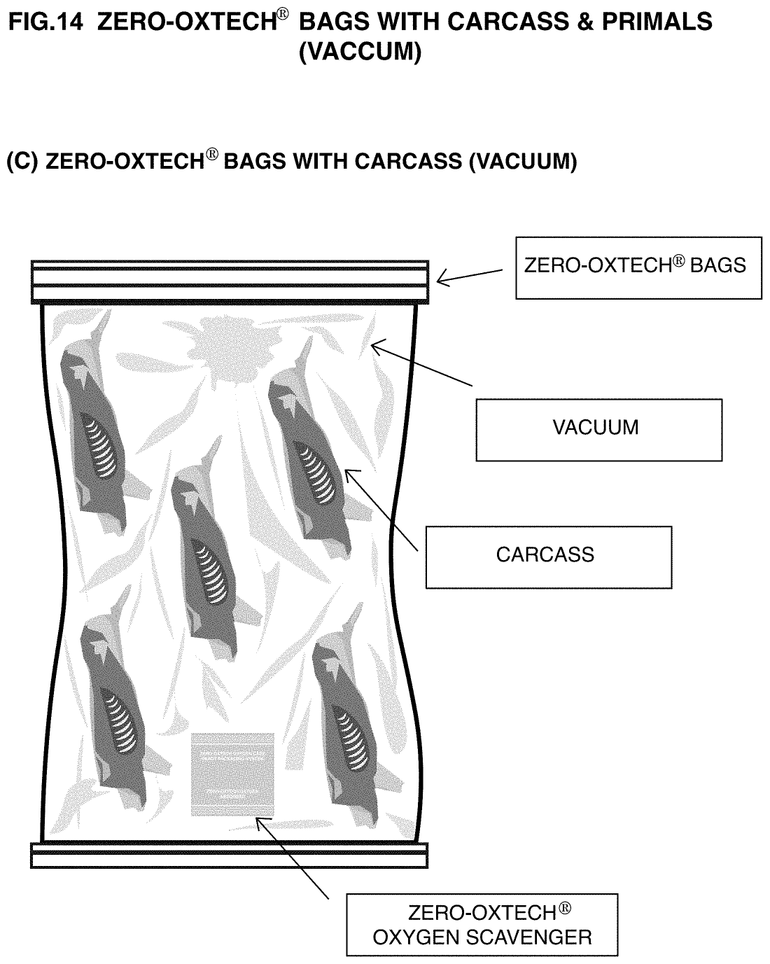

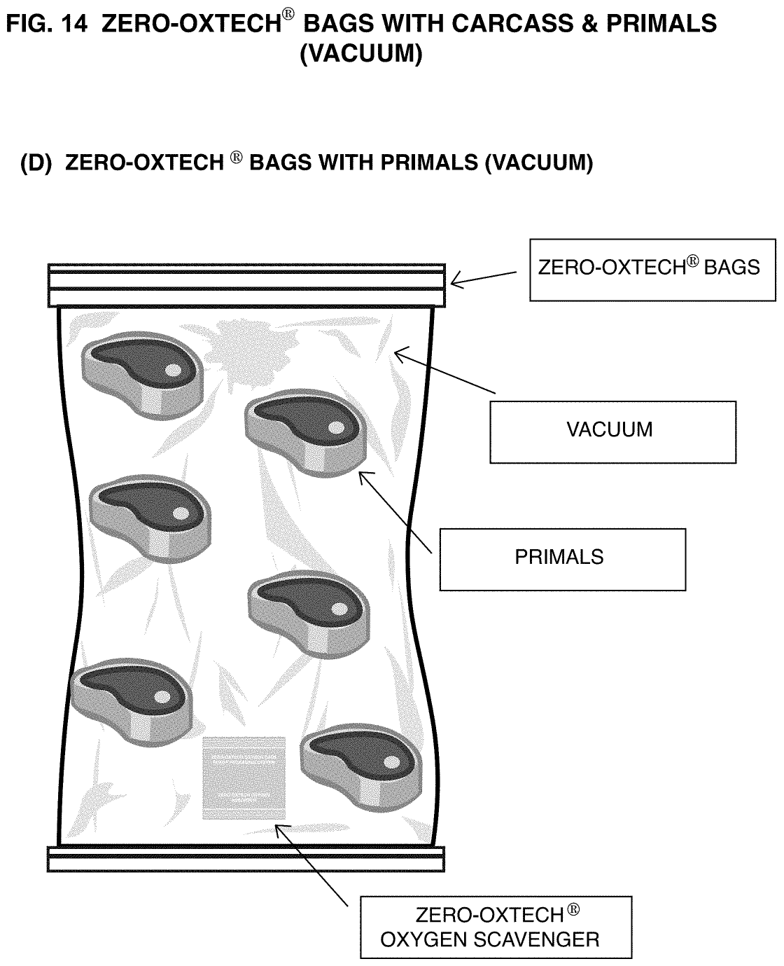

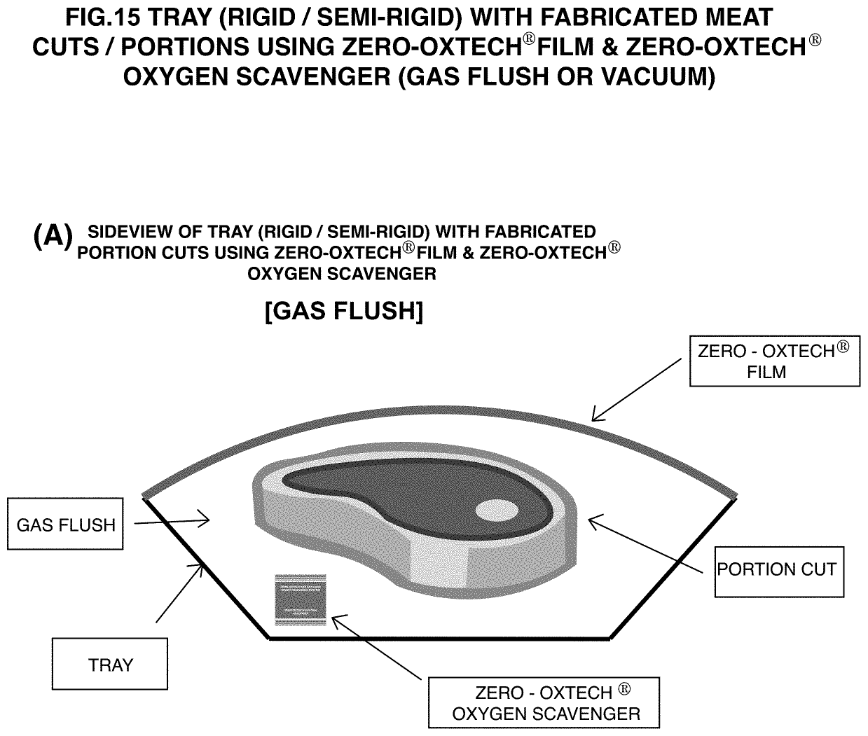

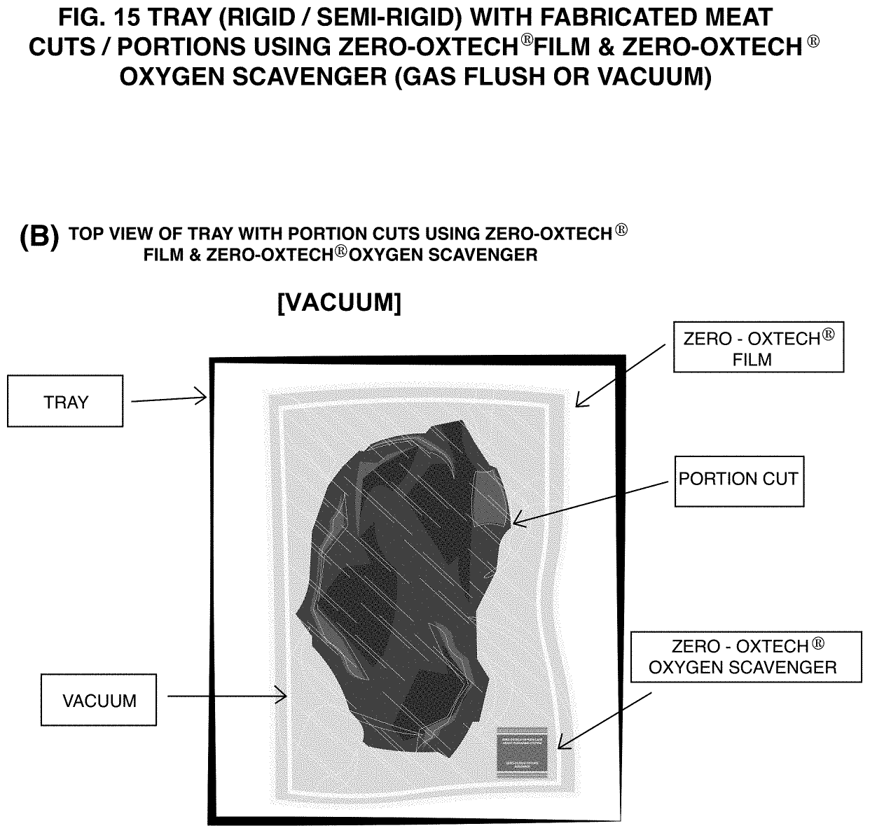

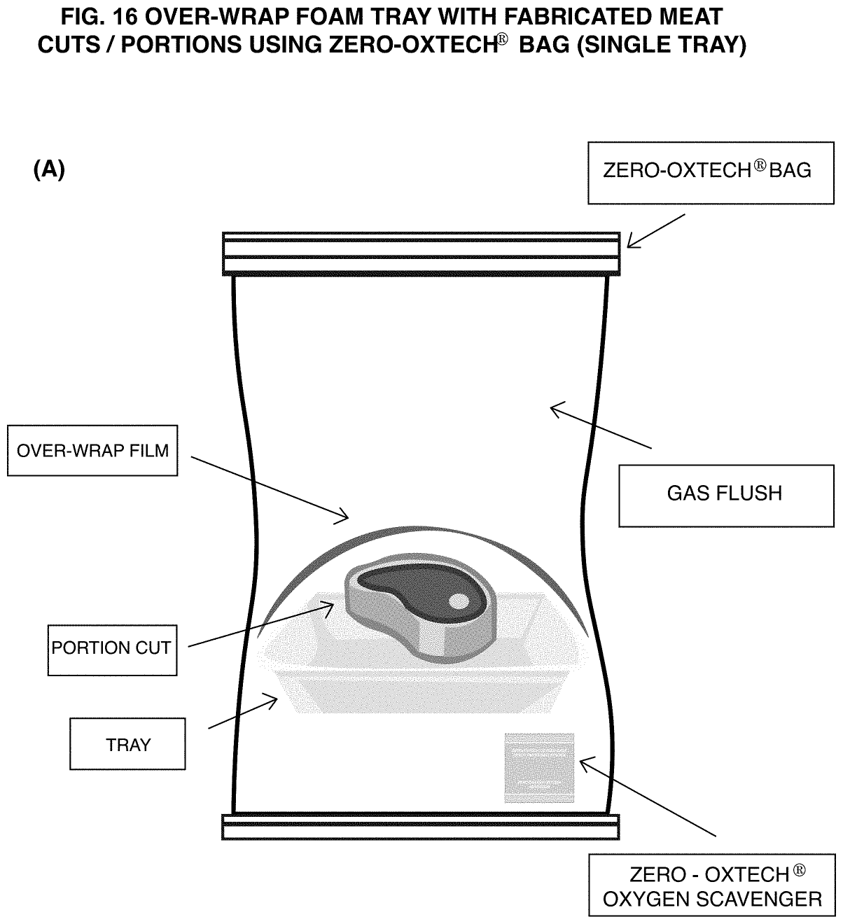

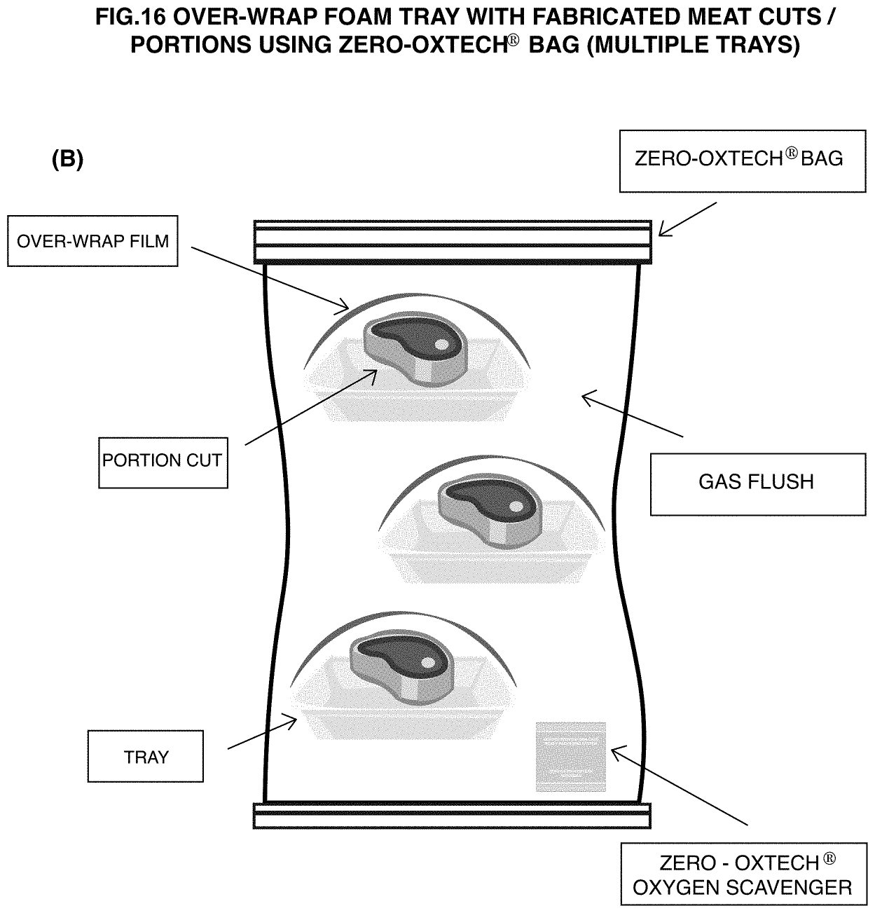

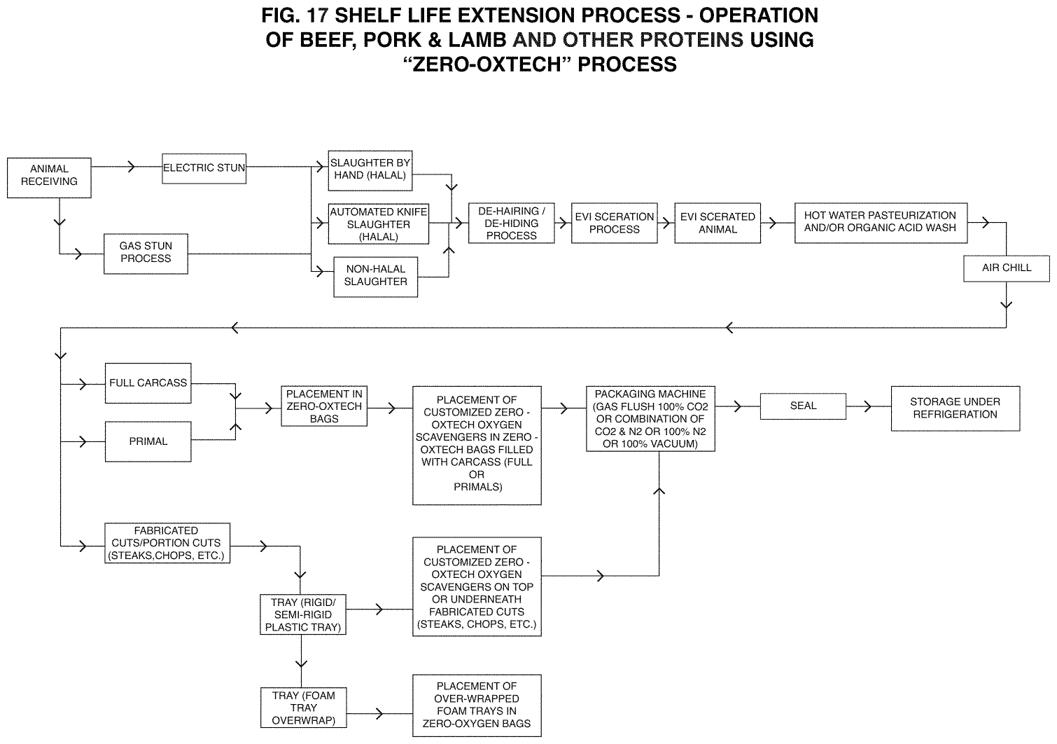

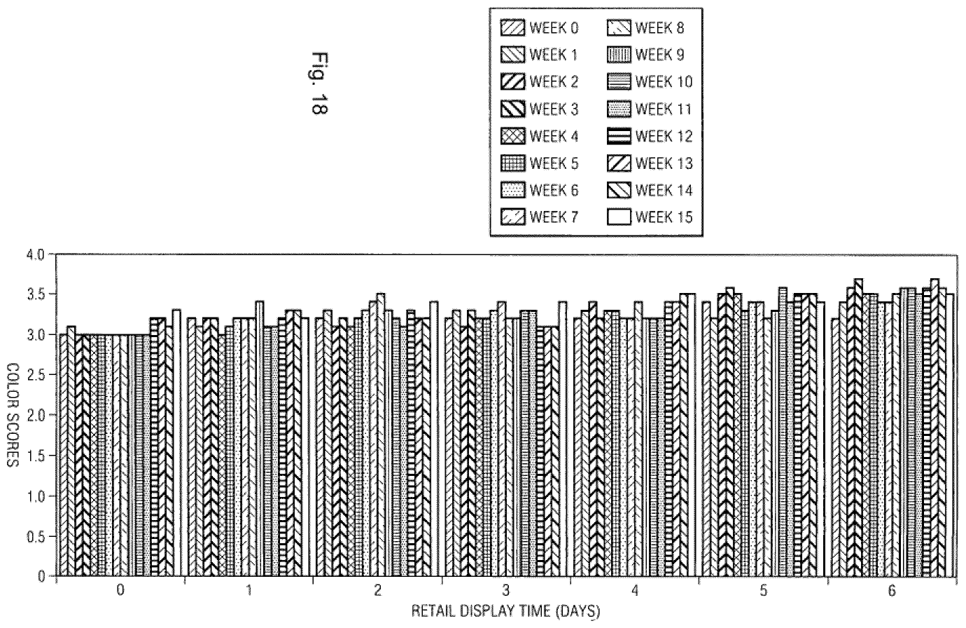

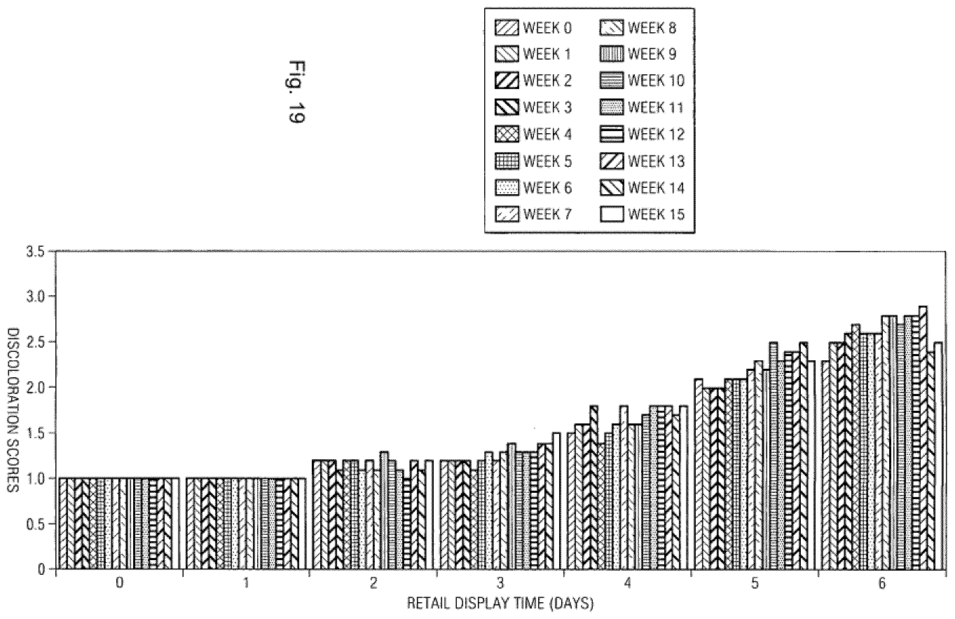

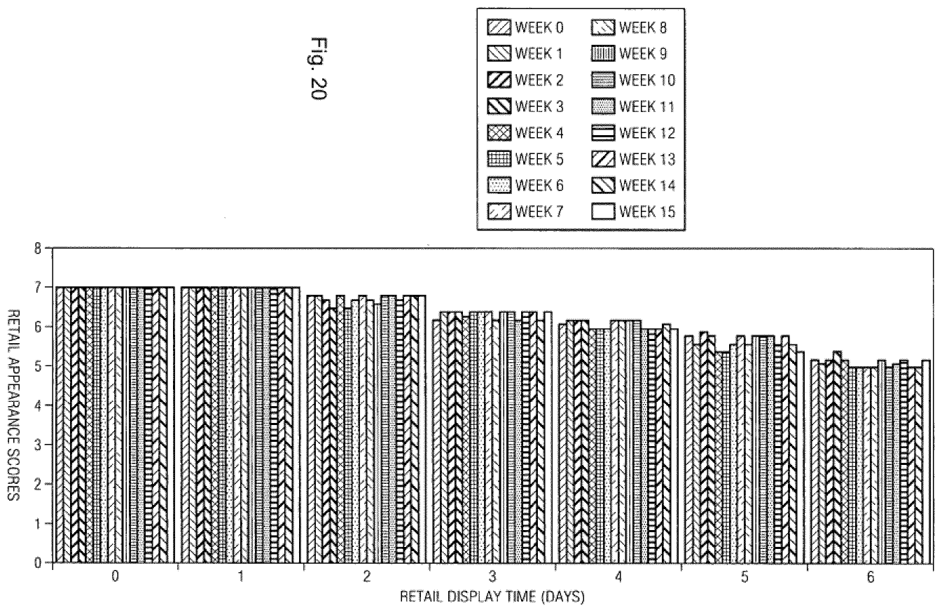

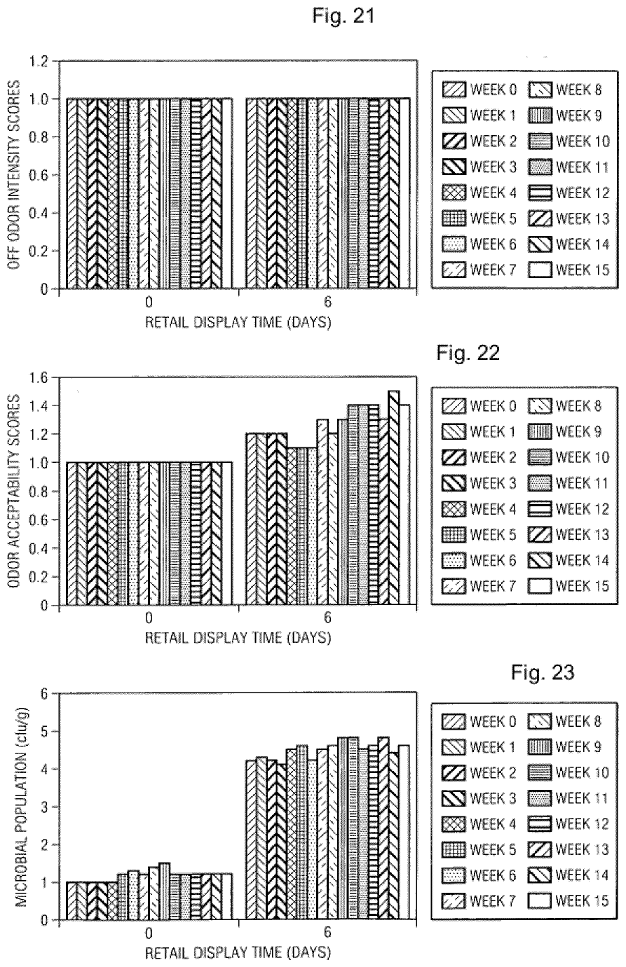

FIG. 1A is a table displaying the half-life of oxygen in bags containing scavengers based upon enzymes and iron chemical systems;

FIG. 1 B is a table showing constants of first order kinetics equation for various scavengers used in the calculation of the Zero-OxTech® process;

FIG. 3 depicts an example of Zero-OxTech® process packaging film structure;

FIG. 4 depicts illustrative picture of closed systems packaging machine;

FIG. 5 depicts illustrative picture of vacuum skin packing machine;

FIG. 6 depicts illustrative picture of Modified Atmosphere Packaging [MAP] machine;

FIG. 7 depicts illustrative picture of open system packaging machine;

FIG. 8 depicts steps in Conventional meat operations;

FIG. 9 depicts steps in Zero-OxTech® centralized meat operations;

FIG. 10 depicts Zero-OxTech® process to produce MAP tray;

FIG. 11 depicts Zero-OxTech® process to produce vac-pac tray;

FIG. 12 depicts Zero-OxTech® process to produce “closed system” packaged tray;

FIG. 13 depicts Zero-OxTech® process to produce “open system” packaged tray;

FIG. 14 depicts illustrative picture of Zero-OxTech® bags with carcass or primal using “open or closed” packaging machine [gas-flush or vacuum];

FIG. 15 depicts illustrative picture of Tray [rigid/semi-rigid] with fabricated meat cuts/portions using Zero-OxTech® film & Zero-OxTech® oxygen scavenger [gas flush or vacuum];

FIG. 16 depicts illustrative picture of over-wrap foam tray with fabricated meat cuts/portions using Zero-OxTech® bags & Zero-OxTech® oxygen scavenger with single or multiple trays [gas flush or vacuum];

FIG. 17 depicts shelf-life extension process-operation of beef, pork & lamb or for any proteins using Zero-OxTech® process;

FIG. 18 is an x-y graph showing mean color score of meats, packaged using Zero-OxTech® process for all Zero-OxTech® packaging configurations;

FIG. 19 is an x-y graph showing mean discoloration score of meats, packaged using Zero-OxTech® process for all Zero-OxTech® packaging configurations;

FIG. 20 is an x-y graph showing mean retail appearance score of meats, packaged using Zero-OxTech® process for all Zero-OxTech® packaging configurations;

FIG. 21 is an x-y graph showing mean off-odor intensity score of meats, packaged using Zero-OxTech® process for all Zero-OxTech® packaging configurations;

FIG. 22 is an x-y graph showing mean odor acceptability score of meats, packaged using Zero-OxTech® process for all Zero-OxTech® packaging configurations;

FIG. 23 is an x-y graph showing mean microbial plate count of meats, packaged using Zero-OxTech® process for all Zero-OxTech® packaging configurations.

1. A process system for preservation of natural MRA enzymes within the protein by creating an absolute zero-oxygen atmosphere surrounding the proteins.

2. A process system for converting the oxymyoglobin pigment in protein to de-oxymyoglobin pigment in protein in an absolute zero-oxygen atmosphere surrounding the protein.

3. A process system for converting the de-oxymyoglobin pigment in protein in an absolute zero-oxygen atmosphere to oxymyoglobin in a high oxygen atmosphere, >20%, surrounding the protein.

4. A Package packaged with process system of claims 1-3, to preserve the natural MRA enzymes, resulting in the shelf-life extension of proteins, comprising of:
a. Protein [case-ready/portion-cut/primal];
b. Specially designed oxygen scavenger based on iron-chemical system to deliver zero ppm in the atmosphere surrounding the protein;
c. Packaging equipment capable to create vacuum+seal or vacuum+gas-flush+seal or gas-flush+seal the atmosphere surrounding the proteins creating an initial oxygen concentration of <10% in the atmosphere surrounding the protein;
d. Packaging film structure surrounding the protein with an ultra-high oxygen barrier property with an OTR of <10 cc/square m at 23° C. dry;
e. Packaging film structure with an ultra-high oxygen barrier property with an OTR of <10 cc/square m at 23° C. dry housing the protein packaged in foam tray with an over-wrap film of OTR>100 cc/square m at 23° C. dry.

5. The packaging system for extending shelf life of protein by preserving natural enzymes of protein of claim 4, wherein the oxygen scavenger comprises of:
a porous bag with an active surface area of between 4 to 64 square inches and porosity levels ranging from 20 to 120 gurly per second;
chemical granules ranging from 0.001 mm to 1.5 mm in diameter; and
a total weight of absorbing chemical of between 1 gram to 300 grams.

6. The packaging system for extending shelf life of protein by preserving natural enzymes of protein of claim 4, wherein the chemical granules comprise:
less than 25% iron;
less than 35% carbon;
less than 20% vermiculite;
less than 10% de-ionized water; and
less than 10% NaCl salt.

7. The packaging system for extending shelf life of protein by preserving natural enzymes of protein of claim 4, wherein the chemical granules comprise less than 10% zeolites.

8. The packaging system for extending shelf life of protein by preserving natural enzymes of protein of claim 4, wherein all the oxygen scavenger sachets sealed within the master bag obtain an absorption capacity of at least 10 mL per pound of protein.

9. The packaging system for extending shelf life of protein by preserving natural enzymes of protein of claim 4, wherein the injected gas comprises of carbon dioxide or nitrogen.

10. The packaging system for extending shelf life of protein by preserving natural enzymes of protein of claim 4, wherein the injected gas comprises:
100% CO2; or
greater than 50% inert gas and balance CO2; or
greater than 50% CO2 and balance inert gas.

11. The packaging system for extending shelf life of protein by preserving natural enzymes of protein of claim 4, wherein the protein consists of beef, pork, lamb, veal, and poultry.

12. The packaging system for extending shelf life of protein by preserving natural enzymes of protein of claim 4, wherein the packaging equipment may be closed system, open system, modified atmosphere packaging for trays or vacuum skin packaging for trays.

12. The packaging system for extending shelf life of protein by preserving natural enzymes of protein of claim 4, wherein the barrier bag has properties similar to that given in FIG. 3;

13. The packaging method for extending shelf life of protein by preserving natural enzymes of protein for long-term storage, as described in FIGS. 4-16, comprising:
packaging meat cuts or primal or full poultry birds or bird pieces, inside or outside of a retail meat tray, inside a sealed oxygen barrier bag used for storage and transport;
vacuum and/or flushing oxygenated air from the oxygen barrier bag to obtain an initial atmosphere containing less than 5% residual oxygen using;
injecting into said oxygen barrier bag a CO2 gas rich mixture of greater than or equal to 50% CO2 and balance nitrogen;
creating vacuum into said oxygen barrier bag;
sealing said oxygen barrier bag, which contains oxygen scavengers of claims 5-6, with first-order oxygen absorption rate, for absorbing the residual oxygen with an absorption capacity reduces the residual oxygen level to 0 ppm within 96 hours of sealing as per the rate-constants of First order oxygen absorption;
storing said master bag at a temperature of between −1.5°-6° C./28°-42° F.

14. The packaging operation for extending shelf life of protein by preserving natural enzymes of protein for long-term storage, as described in FIG. 17, using different and similar packaging configurations as shown in FIGS. 10-16.
